(19) United States
(12) Patent Application Publication
(10) Pub. No.: US 2016/0079592 A1
(43) Pub. Date: Mar. 17, 2016

(54) ALUMINUM BASED ELECTROACTIVE MATERIALS

(71) Applicants: Massachusetts Institute of Technology, Cambridge, MA (US); Tsinghua University, Beijing (CN)

(72) Inventors: Sa Li, Boston, MA (US); Junjie Niu, Malden, MA (US); Kang Pyo So, Everett, MA (US); Chao Wang, Cambridge, MA (US); Ju Li, Weston, MA (US); Yu Cheng Zhao, Beijing (CN); Chang An Wang, Beijing (CN)

(73) Assignees: Massachusetts Institute of Technology, Cambridge, MA (US); Tsinghua University, Beijing (CN)

(21) Appl. No.: 14/857,613

(22) Filed: Sep. 17, 2015

Related U.S. Application Data
(60) Provisional application No. 62/194,050, filed on Jul. 17, 2015.
(60) Provisional application No. 62/181,487, filed on Jun. 18, 2015.
(60) Provisional application No. 62/051,365, filed on Sep. 17, 2014.

(51) Int. Cl. H01M 4/36; H01M 10/0525

(52) U.S. Cl. CPC H01M 4/366; H01M 10/0525; H01M 2220/20

(57) ABSTRACT

An electroactive material including an aluminum nanoparticle core and a nanoshell surrounding the aluminum nanoparticle core as well as its methods of use and manufacture are described.

### CROSS-REFERENCE TO RELATED APPLICATIONS

This application claims the benefit under 35 U.S.C. §119(e) of U.S. provisional application Ser. No. 62/051,365, filed Sep. 17, 2014, U.S. provisional application Ser. No. 62/181,487, filed Jun. 18, 2015, and U.S. provisional application Ser. No. 62/194,050, filed Jul. 17, 2015, the disclosures of which are incorporated by reference in their entirety.

### GOVERNMENT FUNDING

This invention was made with Government support under Grant No. DMR-1120901 awarded by the National Science Foundation. The Government has certain rights in the invention.

### FIELD

Disclosed embodiments are related to aluminum based core and shell electroactive materials.

### BACKGROUND

Alloy-type anodes such as silicon and tin are gaining popularity in rechargeable Li-ion batteries, but their rate and/or cycling capabilities still need to be improved. Further, aluminum should be an attractive anode material for rechargeable Li-ion batteries for many reasons, such as low cost (about $2000/ton), high theoretical capacity (2235 mAh/g if Li₉Al₄), low potential plateau (about 0.19-0.45 V against Li⁺/Li³), high electrical conductivity, etc. However, despite these advantages and the historical efforts directed to developing Al—Li electrodes, and many other high-capacity anodes, the practical performance of aluminum based electrodes has fallen far short of the theoretical promise. The best result thus far came from Park et al., whose hybridized 40 wt % Al/C₆₀ anode showed a capacity of more than 900 mAh/g (milliamp hours per gram) over 100 cycles. Further, most of the batteries made using aluminum films with thicknesses on the order of microns displayed a high initial capacity, but the cell capacity faded rapidly over the course of a few cycles.

### SUMMARY

In one embodiment, an electroactive material includes an aluminum nanoparticle core and a nanoshell surrounding the aluminum nanoparticle core.

In another embodiment, a material includes a nanoshell of TiO₂. A maximum diameter of the nanoshell is between about 10 nm and 100 nm, and a maximum thickness of the nanoshell is between about 1 nm and 10 nm.

In yet another embodiment, a method includes: placing an aluminum nanoparticle having an outer layer of alumina on its exterior surface in an acid bath saturated with TiO(OH)₂; reacting the alumina present on the aluminum nanoparticle with the acid bath to produce water as a product; and reacting the water with a titanium containing compound in the acid bath to precipitate TiO(OH)₂ onto the exterior surfaces of the aluminum nanoparticle to form a nanoshell on the aluminum nanoparticle.

In a further embodiment, an electrochemical device includes a current collector and an electroactive material electrochemically coupled to the current collector. The electroactive material includes an aluminum nanoparticle core surrounded by a nanoshell.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1A is a schematic representation of one embodiment of a synthesis method of nanoparticles including an aluminum (Al) core and titanium oxide (TiO₂) shell (ATO) manufactured using an “in situ water-shift” synthesis method using an equilibrated mixture of H₂SO₄ and TiOSO₄;

FIG. 1B is an X-ray diffraction graph comparing commercial nano aluminum powder and the as-obtained Al core and TiO₂ shell nanoparticles subjected to 4.5 hr etching showing that the original Al₂O₃ layer is completely eliminated after formation and the final product consists of pure metallic aluminum and anatase.

FIG. 2A is a scanning electron micrograph of an Al core TiO₂ shell nanoparticle obtained with an etching time of 4.5 hr including a broken shell;

FIG. 2B is a bright-field transmission electron micrograph of Al core TiO₂ shell nanoparticles at low magnification illustrating inner aluminum cores, or cores, encapsulated by corresponding TiO₂ shells;

FIG. 2C is a higher magnifications of the Al core TiO₂ shell nanoparticles shown in FIG. 2B;

FIG. 2D is an elemental map of Ti of the Al core TiO₂ shell nanoparticles shown in FIG. 2C,

FIG. 2E is an elemental map of O of the Al core TiO₂ shell nanoparticles shown in FIG. 2C, and

FIG. 2F is an elemental map of Al of the Al core TiO₂ shell nanoparticles shown in FIG. 2C;

FIG. 3A is a graph of cycling life and the corresponding Coulombic Efficiency during 500 cycles at a 1 C rate for a half-cell battery including Al core and TiO₂ shell nanoparticles (4.5 hr etching);

FIG. 3B is a graph of charge/discharge voltage profiles for the 1^{st}, 250^{th} and 500^{th} cycles for cycling at a 1 C rate for a half-cell battery including Al core and TiO₂ shell nanoparticles (4.5 hr etching);

FIG. 3C is a graph of cyclability tests conducted at different charge/discharge rates rate for a half-cell battery including Al core and TiO₂ shell nanoparticles (4.5 hr etching);

FIG. 3D is a graph of delithiation capacity evolution for a half-cell battery including Al core and TiO₂ shell nanoparticles (4.5 hr etching) subjected to varying charge/discharge rates ranging 0.1, 0.5, 1, 2, 5, 10 C, and back to 0.1 C over 60 cycles.

FIG. 4A is a scanning electron micrograph of Al core and TiO₂ shell nanoparticles after a coin cell was subjected to 500 cycles

FIG. 4B is a bright-field transmission electron micrograph of Al core and TiO₂ shell nanoparticles illustrating that the core-shell structure was well maintained after 500 cycles;

FIG. 4C is a higher magnification image of FIG. 4B;

FIG. 4D is a chemical element mapping of Ti for the Al core and TiO₂ shell nanoparticles shown in FIG. 4C;

FIG. 4E is a chemical element mapping of O for the Al core and TiO₂ shell nanoparticles shown in FIG. 4C;

FIG. 4F is a chemical element mapping of Al for the Al core and TiO₂ shell nanoparticles shown in FIG. 4C;

FIG. 5 is a TG-DSC curve of an Al core and TiO₂ shell sample heated in argon from 50° C. to 600° C. at a heating rate of 10° C./min;

FIG. 6A is an X-ray diffraction graph of Al core and TiO₂ shell nanoparticles obtained for etching times ranging from 3.0 hr to 10.0 hr;

FIG. 6B is graph of the Al mass ratio for Al core and TiO₂ shell nanoparticles for etching times ranging from 3.0 hr to 10.0 hr as measured with inductively coupled plasma mass spectrometry;

FIG. 6C is a graph of cycling life at a 1 C rate for Al core and TiO₂ shell nanoparticles with etch times between 3.0 hr and 10 hr with the 3.0 hr etching time showing rapid capacity decay after 350 cycles due to the void space between the core and shell being insufficient to completely accommodate swelling of the cores during cycling;

FIGS. 7A-7F are scanning electron micrographs of as-obtained Al core and TiO₂ shell nanoparticles with multiple cores encased in a single shell obtained with an etching time of 4.5 hr;

FIG. 8. is an Energy-dispersive X-ray spectrum and provides the weight fraction of Al of the nanostructure shown in FIG. 7A;

FIG. 9. depicts X-ray diffraction spectra of Al core and TiO₂ shell nanoparticle powders exposed to ambient atmosphere for 24.0 hr and after being ground in air for 20 min followed by exposing to air for another 24.0 hr, as shown in the figure no alumina peaks were detected in both cases indicating negligible oxidation of the aluminum cores;

FIG. 10 is a transmission electron micrograph of hollow TiO₂ shells (without Al) prepared using an etching time of 24 hr where the obvious contrast between the edge and the center of the nanoparticles reveals that the shells are hollow;

FIG. 11A is a graph of the cycling life and the corresponding Coulombic Efficiency during 500 cycles of coin cells made using TiO₂ hollow particles as a cathode and Li foil as an anode at a 1 C rate;

FIG. 11B is a graph of charge/discharge voltage profiles of the 1^{st}, 250^{th} and 500^{th} cycles of a coin cell made using TiO₂ hollow particles as a cathode and Li foil as an anode at a 1 C rate;

FIG. 12A is a graph of the cycling life and the corresponding Coulombic Efficiency during 500 cycles of coin cells made using Al core and TiO₂ shell nanoparticle (4.5 hr etching) as a cathode and Li foil as an anode at a 0.1 C rate;

FIG. 12B is a graph of charge/discharge voltage profiles of the 1^{st}, 50^{th} and 100^{th} cycles of a coin cell made using Al core and TiO₂ shell nanoparticle (4.5 hr etching) as a cathode and Li foil as an anode at a 0.1 C rate;

FIG. 13 is a graph of X-ray diffraction patterns of an Al core and TiO₂ shell nanoparticle (ATO) anode before and after various numbers of cycling which shows that with increased cycling the Al FCC diffraction peaks at 38°, 44°, 65° and 78° decrease indicating that the aluminum inside likely has turned amorphous;

FIG. 14A is a graph of cyclability tests at different charge/discharge rates over 750 cycles of coin cells made using 4.5 hr etched Al core and TiO₂ shell nanoparticles (ATO) as an anode and Li foil as a cathode;

FIG. 14B is a graph of the specific capacity calculated at different charge/discharge rates using the mass of pure aluminum for coin cells made using 4.5 hr etched Al core and TiO₂ shell nanoparticles (ATO) as an anode and Li foil as a cathode compared to pure aluminum;

FIG. 15 is a transmission electron micrograph of 3.0 hr etched Al core and TiO₂ shell nanoparticles after 450° C. annealing for 1.0 hr;

FIG. 16 is a cyclic voltammetry curve of an Al core and TiO₂ shell nanoparticle (ATO)/Li half-cell scanned at 0.1 mV/s;

FIG. 17A is a graph of cycling life and the corresponding Coulombic Efficiency during 200 cycles for lithium-matched Al core and TiO₂ shell nanoparticles (ATO)/1M LiPF₆ EC:DEC/LFP full cells with only about 50% excess total lithium in the entire cathode and electrolyte salt cycled between 2.5 V-4.0 V with a 1 C-rate (1410 mA g⁻¹ of Al core and TiO₂ shell nanoparticle);

FIG. 17B is a graph of charge/discharge voltage profiles for lithium-matched ATO/1M LiPF₆ EC:DEC/LFP full cells with only about 50% excess total lithium in the entire cathode and electrolyte salt for the 1^{st}, 100^{th} and 200^{th} cycle;

FIG. 18 is a schematic representation of a possible mechanism of reversible water-related redox shuttle inside an electrolyte; and

FIG. 19 is a graph of mass gain of SEI on Al core and TiO₂ shell nanoparticles (ATO) in a lithium-matched Al core and TiO₂ shell nanoparticle/1M LiPF₆ EC:DEC/LFP full cell after 50, 100, 150 and 200 cycles relative to the initial ATO weight (without binder and carbon black), two LFP/Al core and TiO₂ shell nanoparticle full cells were used for the average for each cycling condition.

### DETAILED DESCRIPTION

Without wishing to be bound by theory, the inventors have recognized that the development of a high capacity aluminum based electroactive material has been limited due to two damage mechanisms, both of which are exacerbated by aluminum's roughly 100% volume expansion/shrinkage during lithiation/delithiation. First, the volume changes cause repeated breaking and re-formation of the solid-electrolyte interphase (SEI) film coating the active material. This results in the Coulombic Efficiency (CE) not equaling 100% during a cycle thus converting cycleable or “live” lithium in the electrodes and electrolyte to “dead lithium” in the SEI films which eventually causes the battery to die due to lithium exhaustion. Second, the active material (Al—Li) may be pulverized and/or pushed away from an electrode during cycling, thus losing electrical contact with the current collector it is associated with. The above issues have been addressed in a similar material system where Si is contained in a C shell with a predefined void space. In this arrangement, the inert nanoshell facing the electrolyte is covered with SEI but does not change in volume, while the active core expands/shrinks in the internal cavity without forming SEI. Due to the thin carbon shell conducting both Li⁺ and electrons, even if the core pulverizes, the active contents are still confined in the closed shell and will not lose electrical contact. However, the methods used for forming a carbon nanoshell around a silicon nanoparticle core are not compatible with an aluminum based material system.

In view of the above, the inventors have recognized that methods for implementing a similar strategy for use in an aluminum-based system are desirable. However, in developing a material including a nanoshell at least partially surrounding a nanoparticle aluminum core, the inventors have recognized several competing design factors. One such factor includes developing a manufacturing process that is cost-effective and industrially scalable. It is also desirable to form a nanoshell with appropriate materials and thickness to enable sufficient electron and Li⁺ conduction while still being mechanically robust enough to resist internal stresses generated during lithiation/delithiation. Depending on the embodiment, a substantially, or fully, closed nanoshell may be used to separate the active aluminum material from the surrounding electrolyte to prevent the formation of SEI. Additionally, in some embodiments, to help avoid failure modes related to the volume expansion of aluminum of about 100%, the shell-enclosed volume (70 3/6, where D is the inner diameter of the nanoshell) may be greater than the volume of the aluminum nanoparticle contained in the shell (πd₀³/6, where d₀ is the diameter of the aluminum core before lithiation) as detailed further below.

Based on the forgoing, in one embodiment, an electroactive material includes one or more aluminum nanoparticle cores surrounded by a nanoshell. The resulting structure including a nanoparticle core surrounded by a nanoshell may sometimes be referred to as a core-shell nanoparticle. In some embodiments, the nanoshell may be disposed on the one or more nanoparticles surfaces. However, in another embodiment, the one or more nanoparticles may have a volume that is less than an internal volume of the nanoshell such that a void space is formed between a surface of the nanoparticles and the internal surface of the nanoshell. In addition to the above, while any appropriate material may be used for the nanoshell that is capable of conducting one or more desired ions and/or electrons, such as lithium ions, in one embodiment, the nanoshell comprises titanium dioxide (Ti0₂).

Without wishing to be bound by theory, defects, such as holes or tears, present in a nanoshell may permit liquid electrolyte into the nanoshell interior either through conduction and/or convection. In such a situation, the aluminum nanoparticle may come into contact with the liquid electrolyte and generate an SEI directly on the aluminum nanoparticle surface. Again, generation of SEI on the aluminum nanoparticle may result in several different failure modes as detailed above. Therefore, to help avoid the above noted issues, in some embodiments, a nanoshell may enclose the nanoparticle core such that the nanoparticles does not come in contact with a liquid electrolyte located external to the nanoshell. In the above noted arrangements, the nanoshell separates the aluminum nanoparticle from the liquid electrolyte. Therefore, the generation of an SEI layer may be suppressed and/or eliminated. Further, if the aluminum nanoparticle core, i.e. core, is pulverized during repeated charge and discharge cycling, the pulverized core is still retained within the nanoshell permitting the electroactive material to still function. For example, in one embodiment, a nanoshell may be impermeable to the electrolytes, such as an organic electrolyte, used within an electrochemical device. In order to do so, in some embodiments, the nanoshell may fully enclose the core. Further, any defects present within the nanoshell may have dimensions that are less than or equal to four carbon chain lengths, or about 700 pm, to help exclude the electrolyte from the nanoparticle interior. However, it should be understood that nanoshells including larger defects and/or openings are also contemplated as the disclosure is not so limited.

While fully enclosed nanoshells are discussed above, in some instances defects that do permit the exchange of some amount of liquid electrolyte across the nanoshell may be present. However, the nanoshell may still at least slow down the reaction of the active material with the electrolyte to form SEI.

While the above embodiments have described a nanoshell surrounding a single nanoparticle core, in some embodiments, a core-shell nanoparticle may contain multiple nanoparticle cores contained within a single nanoshell. For example, a plurality of nanoparticle cores, may be disposed within a nanoshell that surrounds the plurality of nanoparticle cores. As noted above, the nanoshell may fully enclose the plurality of nanoparticle cores such that the nanoshell excludes liquid electrolyte from the core-shell nanoparticle interior. In such an embodiment, it should be understood that a nanoshell may have any appropriate shape such that it encloses the multiple nanoparticle cores including both spherical shapes and/or non-spherical shapes as the disclosure is not limited in this fashion.

Depending on the particular application, a nanoparticle core may have any appropriate size. For example, a nanoparticle core may have a maximum diameter that is greater than 1 nm, and 10 nm, and 20 nm, 30 nm, 40 nm, 50 nm, or any other appropriate length. Correspondingly, a nanoparticle core may have a maximum diameter that is less than 100 nm, 90 nm, 80 nm, 70 nm, 60 nm, 50 nm, or any other appropriate length. Combinations of the above are contemplated, including a nanoparticle core with a maximum diameter between or equal to 10 nm and 100 nm though other combinations as well as other maximum and minimum diameters greater than or smaller than those noted above are also contemplated.

All the above embodiments have described a nanoparticle core located within a nanoshell. However, in some embodiments, the nanoparticle core may be completely etched from within a nanoshell such that the nanoshell is empty. Therefore, in some embodiments, a nanoshell may simply include void space within the nanoshell interior without a nanoparticle core located therein. In such an arrangement, the nanoparticle core may be considered as having a dimension of zero. Therefore, a generalized range of nanoparticle core sizes covering both nanoshells without cores as well as nanoshells enclosing one or more nanoparticles cores may be viewed as nanoparticle cores with a maximum diameter between or equal to 0 nm and 100 nm.

Depending on the desired electochemical properties, a nanoshell may have any appropriate thicknesses. Without wishing to be bound by theory, modeling shows that a TiO₂ shell with a thickness less than about 10 nm may provide increased ionic conductivity for ionic lithium as compared to thicker TiO₂ shells. Further, since TiO₂ has a much lower lithium storage capacity than aluminum, thinner shells may also correspond to a higher specific capacity of a TiO₂-nanoaluminum hybrid material. Thus, in some embodiments, a TiO₂ nanoshell may have a thickness that is less than or equal to 10 nm, 5 nm, or any other appropriate thickness capable of providing sufficient ionic transport. However, the desire for a thin nanoshell for ionic transport is balanced against sustaining tensile loads applied to the materials during cycling without rupturing. Therefore, a nanoshell thickness and/or material may be selected such that it provides sufficient ionic transport as well as sufficient tensile strength to avoid rupture. Again, without wishing to be bound by theory, there is strong evidence that nanoscale oxides, such as TiO₂, have fundamentally different mechanical behavior than its macroscale counterpart, and can be surprisingly robust mechanically. Therefore, it is believed that nanoshells made with these materials and having thicknesses greater than or equal to 1 nm are sufficient. In view of the above, a nanoshell may have a thickness that is between or equal to about 1 nm and 10 nm, 1 nm and 5 nm, or any other appropriate range of thicknesses. It should also be understood that nanoshell thicknesses both greater than and less than those noted above are contemplated. Additionally, it should be understood that while nanoshells made from TiO₂ have been described above, nanoshells having the same, or different, dimensions as those noted above, may be made from TiO₂ or any other appropriate material as the disclosure is not so limited.

The above ranges of core and shell diameters and thickness may be combined with one another. For example, in one specific embodiment, a material may include a plurality of TiO₂ nanoshells with an outer maximum diameter between or equal to about 10 nm and 100 nm and a maximum thickness between or equal to about 1 nm and 10 nm. As noted above, depending on the particular application, a nanoshell may or may not include a nanoparticle core having a dimension equal to or less than that of the nanoshell.

As noted above, in some embodiments, a core-shell nanoparticle may include a nanoparticle core located within the nanoshell. In such an embodiment, a volume enclosed by the nanoshell may be greater than or equal to a volume of the nanoparticle core when delithiated to accommodate the expected expansion of the material during litiation. For example, the nanoshell may have an internal diameter of D and the nanoparticle core may have an external diameter of d_{O}. Further, the two volumes may be related to one another by a fill factor B as shown in the equation below.

πD³/6=πd₀³/6×B

While any appropriate fill factor may be used depending on the particular materials and desired electrochemical properties, in some embodiments, a material including an aluminum nanoparticle core may have a fill factor/ratio of the nanoshell interior volume to the nanoparticle volume that is greater than 2, 2.5, 3, or any other appropriate ratio. It is noted that increased ratios of internal nanoshell volume to nanoparticle volume may result in reduced volumetric specific capacity of the core-shell nanoparticle and increased diffusion distance, which may lead to polarization and/or poor rate performance of the electrodes. Therefore, in some embodiments, the fill factor/ratio of the nanoshell interior volume to the nanoparticle volume may be less than 4, 3, 2.5, or any other appropriate ratio. Combinations of the above ranges are contemplated. For example, in one embodiment, a nanoshell interior volume may be between or equal to 2 times and 4 times the volume of a nanoparticle core contained therein.

As discussed herein, in some embodiments, the electroactive compounds are solid, and in some cases, crystalline. For example, the materials forming the core and/or shells may be arranged in a repeating array having a definite crystal structure, i.e., defining a unit cell atomic arrangement that is repeated to form the crystal structure. Further, depending on the embodiment, a particular crystal structure for the core and/or shell may be desirable. For example, a particular crystal structure of a nanoshell and/or nanoparticle may be desirable for either strength and/or conductive properties. For instance, in one embodiment, a TiO₂ nanoshell may be appropriately annealed and quenched such that it has a rutile crystal structure, an anatase crystal structure, or any other desired crystal structure. Similarly, in some embodiments, the core contained within a shell may be an aluminum core with a face centered cubic (FCC) crystal structure, an amorphous structure (i.e. no long range crystal order), or any other appropriate crystal structure as the disclosure is not so limited. Of course, it should be understood that while several specific crystal structures are noted above, combinations of the above, and/or any other appropriate crystal structure, may be present in either the core and/or shell of a nanoparticle as the disclosure is not so limited. The presence of crystal systems such as those described above may be determined using any suitable technique known to those of ordinary skill in the art including, for example, TEM, X-Ray diffraction or the like as discussed herein.

In some cases, elements other than those primarily forming the core and/or shell of a nanoparticle structure may be present (e.g., as substituents or trace impurities in the materials). However such elements may not, in some embodiments, substantially alter the properties or crystal structures of the resulting core-shell nanoparticles. Therefore, compounds including materials other than pure Al and TiO₂ are considered as being part of the present disclosure. For instance, elements such as sodium, potassium, strontium, barium, aluminum, magnesium, calcium, bismuth, tin, antimony, or other transition metals such as scandium, copper, zinc, yttrium, zirconium, niobium, molybdenum, tungsten, etc. may be found in one or both of the shell and/or core of a nanoparticle.

In one set of embodiments, an Al core TiO₂ shell nanoparticle based compound may have a reversible specific discharge capacity greater than or equal to 200 mA h/g, 600 mA h/g, 800 mA h/g, 1000 mA h/g, or any other appropriate reversible specific discharge capacity as measured at a discharge rate of 1 C. Similarly, the compound may have a reversible specific discharge capacity less than or equal to about 1400 mA h/g, 1200 mA h/g, 1000 mA h/g, or any other appropriate reversible specific discharge capacity as measured at a discharge rate of 1 C. Combinations of the above ranges may be used including, for example, a reversible specific discharge capacity of the compound may be between or equal to 200 mA h/g and 1400 mA h/g or 1000 mA h/g to 1400 mA h/g though combinations of the above ranges are also contemplated. The specific discharge capacities may be measured, for example, by using the relevant compound as a positive electrode in an electrochemical cell against a Li anode and cycling the electrochemical cell as described in the examples below. It should also be understood that compounds having reversible specific discharge capacities both greater than and less than those noted above are contemplated. Depending on the embodiment, the reversible specific discharge capacities noted above may remain substantially the same for at least 100, 200, 300, 400, 500, or any appropriate number of cycles.

A core-shell nanoparticle based compound as discussed herein may be used in any number of electrochemical devices. These include, but are not limited to use in both primary batteries, secondary batteries, capacitors, and super capacitors to name a few. While the disclosed materials may be of use in any number of different electrochemical systems, these materials may be of particular use in Li-ion based and other similar electrochemical devices. In some embodiments, a material including a plurality of core-shell nanoparticles may be used in an electrochemical device. For example, the core-shell nanoparticles may function as an electroactive material on at least one of first and second opposing electrodes in an electrochemical device. In such an embodiment, the electroactive material is electrically coupled to an associated current collector. In order to appropriately couple the electroactive material to the associated current collectors as well as providing ionic conduction between the two opposing electrodes, one or more electrolytes and/or binders may be used in conjunction with the presently disclosed materials to form the electrodes. While a particular type of electrochemical structure is described above, it should be understood that the presently disclosed materials are not limited to only this application as the disclosure is not so limited.

As noted above, in some embodiments, core-shell nanoparticles, such as those described herein, may be formed into electrodes (e.g., a cathode) for use in an electrochemical device. For instance, the particles may be pressed, optionally with carbon, binders (e.g., polytetrafluoroethylene, polyvinylidenefluoride, etc.), fillers, hardeners, or the like to form a solid article useable as an electrode in an electrochemical device. The electrode may have any suitable shape for use within such a device including plate arrangements, jelly rolls, as well as coin cell electrodes to name a few. In some cases, at least about 50 weight percent (wt %) of the electrode is formed from the core-shell nanoparticles described herein, and in some cases, at least about 75 wt %, at least about 80 wt %, at least about 85 wt %, at least about 90 wt %, at least about 95 wt %, or at least about 99 wt % of the electrode is formed from the core-shell nanoparticles described herein. Further, in some embodiments, the electroactive material may be comprised from substantially only the core-shell nanoparticles without any binders or fillers. However, in some embodiments, and as noted previously, various forms of carbon, binders, fillers, hardners, and/or other appropriate materials may be present as part of the electrode such that they form about 5 wt %, about 10 wt %, about 15 wt %, or any other appropriate weight percent of an electrode as the disclosure is not so limited.

In addition to the use of the presently described materials in electrochemical devices, TiO₂ nanoparticles are also often used as photocatalysts. Therefore, in some embodiments, a material including a plurality of TiO₂ nanoshells may be used as a photocatalyst. Depending on the particular application, the nanoshells may or may not include nanoparticle cores contained therein.

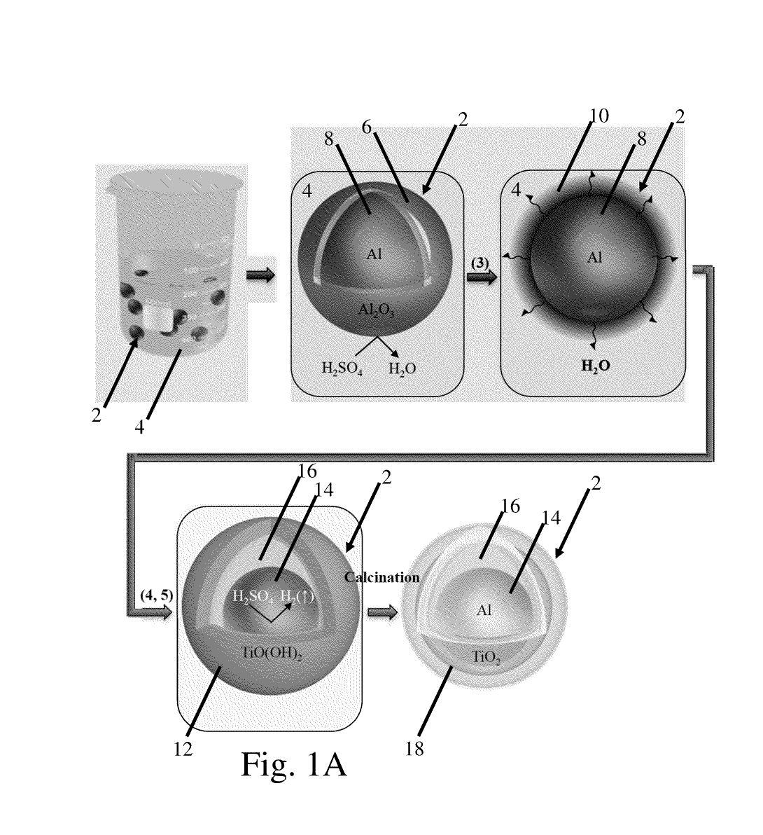

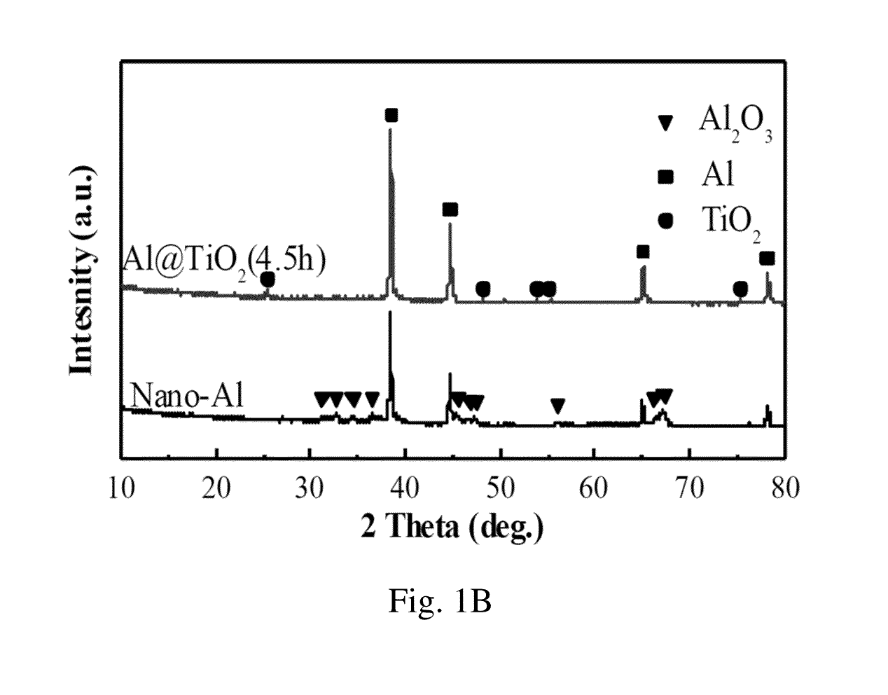

Having described several materials and their methods of use above, one exemplary embodiment of a method for manufacturing core-shell nanoparticles is described below in regards to FIG. 1A. First a plurality of aluminum nanoparticles 2 are placed into an acid bath 4. Depending on the embodiment, any number of acids might be used. However, in one embodiment, the acid bath includes a water based sulfuric acid H₂SO₄ bath. Additionally, the acid bath is saturated with a Ti containing compound such as oxysulfate (TiOSO₄). The bath is also at the solubility limit of TiO(OH)₂. The aluminum nanoparticles include an outer layer of alumina 6 on the exterior surfaces of the internal bulk aluminum 8 forming the majority of the aluminum nanoparticles. Thus, once placed into the acid bath, the alumina present on the aluminum nanoparticles reacts with the acid bath to produce water 10 as a product. The resulting water, which is located adjacent to the associated aluminum surfaces, then reacts with the titanium containing compound in the acid bath to form TiO(OH)₂. Since the acid bath is already saturated with TiO(OH)₂, and the produced excess water is adjacent to the parent aluminum nanoparticle, the reaction precipitates TiO(OH)₂ onto the exterior surfaces of the aluminum nanoparticles to form a TiO(OH)₂ nanoshell 12 with an aluminum nanoparticle core 14 located therein.

The resulting nanoshell 12 of TiO(OH)₂ is permeable relative to the acid bath. Consequently, it is possible to etch the nanoparticle core 14 through the nanoshell. Depending on the particular strength of the acid bath as well as the desired size of the final nanoparticle core relative to the initial aluminum nanoparticle size, etching is continued for a time sufficient to provide a desired amount of void space 16 corresponding to the size difference between the nanoshell's internal volume and a volume of the nanoparticle core. In some instances etching is continued until the nanoparticle core is completely dissolved, as the disclosure is not limited to any particular size of nanoparticle core. One method for determining an appropriate etching time for a given bath strength is to sample and test nanoparticles from a single batch for different etch times.

As also shown in FIG. 1A, after etching a nanoparticle core to a desired size within a surrounding nanoshell, the resulting material may be subject to a calcining process to form the final nanoshell material. For example, a TiO(OH)₂ nanoshell 12 may be calcined to form a TiO₂ nanoshell 18. In the case of aluminum-TiO₂ core-shell nanoparticles, calcining may be accomplished using annealing temperatures greater than 100° C. and less than a melting temperature of the core and/or a melting temperature of the nanoshell material. For example, for an aluminum-TiO₂ core-shell nanoparticle, the annealing temperature may be greater than 100° C. and less than about 480° C. corresponding to the melting temperature of the aluminum. However, temperatures both greater than and less than those noted above are contemplated as the currently disclosed methods are not limited to any particular temperature range.

Method for Preparing Al Core and TiO₂ Shell Nanoparticles

Having described a synthesis method generally, the specific reactions and intermediary steps for one possible embodiment of such a synthesis route are detailed below. Specifically, the present method was developed to provide a one-pot synthesis method that is simple, cheap, scalable and uses only Earth-abundant elements (Al, Ti, O, hr, C, S) and therefore can be mass-produced easily and cheaply. However, depending on the embodiment, different elements and/or processes might be used as well. The synthesis method was derived somewhat serendipitously. It started from the observation that some commercial aluminum powders come with a relatively thick adherent surface oxide layer of Al₂O₃ (alumina). Even though an ultrathin alumina membrane provided by atomic layer deposition on high-capacity anodes may be used to enhance performance, such a thick layer of natural alumina is a detriment to battery performance and needed to be removed. However, the inventors realized that even if chemical methods could be utilized to eliminate the natural alumina layer, the freshly exposed bare aluminum would be oxidized again very quickly when in air. Therefore, the inventors recognized the benefits associated with using a wet chemical environment in which the thick adherent natural alumina layer can be converted to a beneficial, non-adherent shell made from a material such as TiO₂. Such a process would create an Al core and TiO₂ shell structure (ATO) providing for an air-stable and long-cycle life anode. In other words, the inventors have developed a process that converts the thick adherent alumina normally present on aluminum particles to a desirable partially detached TiO₂ shell using the chemistries noted below.

In one embodiment, a chemical route for the “wet conversion” of alumina to a TiO₂ shell is conducted in a water-based sulfuric acid (H₂SO₄) bath. While any molarity acid may be used, in one embodiment, the concentration of H⁺ ions in the acid bath solution may be between or equal to about 0.5 M-2 M, though any appropriate molarity might be used. For example, in one embodiment, the molarity may be about 1 M. In addition to the above, in some embodiments, the acid bath may be saturated with a titanium compound such as oxysulfate (TiOSO₄). Specifically, in some embodiments, a concentration of TiOSO₄ (aq) in the bath may be at the solubility limit of solid TiO(OH)₂. In some instances, excess TiOSO₄ results in TiO(OH)₂ precipitating out of solution to rest on the bottom of the acid bath which may be filtered out at a later time. The reaction of TiOSO₄ with water to form TiO(OH)₂ is shown below:

TiOSO₄(aq)+2H₂O(aq) [symbol] TiO(OH)₂(sol)+H₂SO₄(aq)

Again as shown in FIG. 1A, aluminum powders having any desirable diameter and which have a surface layer of natural alumina are placed into the acid bath. The following “water-shift” reactions then take place:

Al₂O₃+3H₂SO₄→Al₂(SO₄)₃(aq)+3H₂O

In the above, alumina is converted into extra water and soluble aluminum sulfate that diffuses away from the particle. The extra water then shifts the thermodynamic balance of TiOSO₄ and TiO(OH)₂ to the right-hand side of the equation below.

TiOSO₄(aq)+2H₂O→TiO(OH)₂↓+H₂SO₄

Since the bath is already at the solubility limit of TiO(OH)₂, the reaction precipitates out solid TiO(OH)₂, which due to the proximity of the extra water relative to the aluminum nanoparticle forms a nanoshell on the nanoparticle in situ, by nucleation and growth at the original diameter D₀. Since alumina is being consumed in the above process, the original particle recedes as the solid shell grows. Therefore, the TiO(OH)₂ solid shell with a diameter of D₀ starts to detach from the original aluminum nanoparticle at this point forming a TiO(OH)₂ shell enclosing an aluminum core. Once the alumina is completely consumed, the below reaction takes place between the acid in the bath and the aluminum core due to the TiO(OH)₂ shell being permeable to H⁺, SO₄²⁻, Al³⁺ ions.

2Al+3H₂SO₄→Al₂(SO₄)₃(aq)+3H₂(g)↑

This reaction of the aluminum core with the acid bath further separates the core and the shell allowing the void space between the core and shell to grow. Experimentally, it was observed that the reaction of the core with the acid bath happens slowly, on the timescale of hours. For example, an etch time may between or equal to about 1 hr to 24 hr, 2 hr to 12 hr, 3 hr hr to 6 hr, 4 hr to 5 hr, 4.5 hr, and/or any other appropriate time period to provide a desired ratio of the nanoshell internal volume to the volume of the enclosed core. Without wishing to be bound by theory, this slow etching of an aluminum nanocore when there is plenty of acid in the solution proves that by the time Al₂O₃ is gone, the TiO(OH)₂ shell is already fully enclosed and semi-protective thus preventing the bulk acid from flowing inside of the nanoshell by convection or conduction. However, the solid TiO(OH)₂ shell still allows H⁺, SO₄²⁻, Al³⁺ ion exchange through the shell, probably through grain boundary (GB) diffusion. So, it is believed that a GB diffusion-controlled, instead of convection-controlled, kinetics govern the continuous etching of the aluminum core. Further, it is also believe that the time it takes to form a TiO(OH)₂ nanoshell on an aluminum particle in acid is nearly instantaneous, so practically all of the wet-processing time is spent on the last reaction etching the aluminum nanocore, and this time duration, t_{etch}, is the primary variable to be optimized because it controls the fill factor B discussed above. After formation and etching, the aluminum core TiO(OH)₂ shell nanoparticle powder is harvested by vacuum filtering.

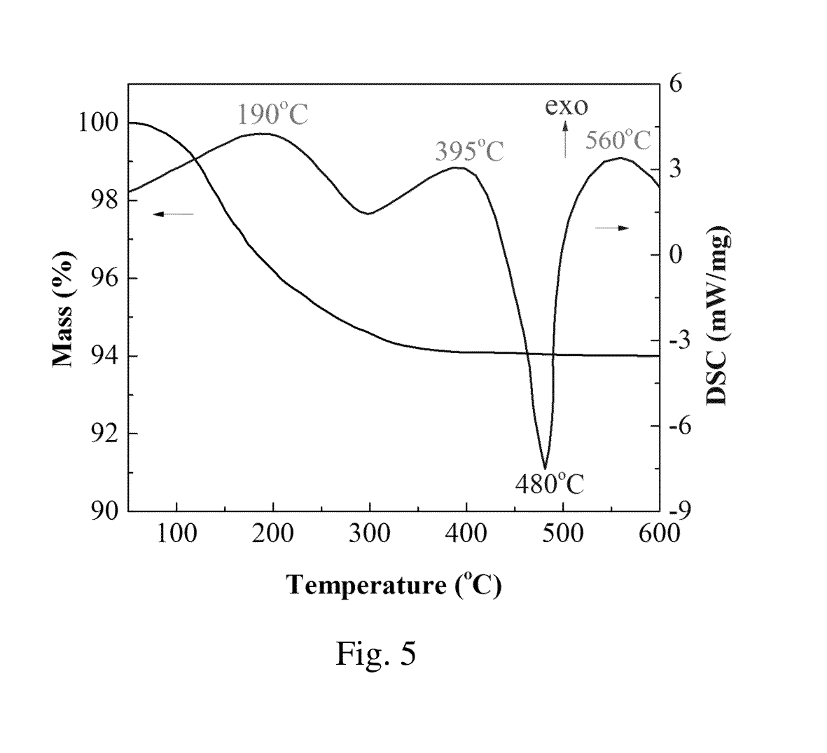

After harvesting the aluminum core TiO(OH)₂ shell nanoparticle powder is calcined to get the final Al core and TiO₂ shell (ATO) powder. Depending on the embodiment, the calcining process may be conducted in an inert atmosphere such as argon, though other inert gases might be used. Other than the calcining process the remaining synthesis processes may be conducted at room temperature exposed to normal air though an inert atmosphere and/or elevated temperatures might also be used in those other steps as well as the disclosure is not so limited. During the calcining process the shell shrinks some. To optimize this step, TG-DSC analysis may be carried out as shown in FIG. 5. As shown in the figure, the TiO(OH)₂ shell first undergoes dehydration with a weight loss of about 6% at a temperature range of 100-300° C. Then with continuous heating, negligible weight loss is observed while two exothermic peaks and one endothermic peak appear, which belongs to phase transformations of amorphous TiO₂ to anatase (395° C.), anatase to rutile (560° C.), and aluminum melting (480° C.), respectively. Based on the TG-DSC result, the annealing temperatures may be greater than 300° C. to dehydrate the material. It is believed that the entire process described above is industrially scalable with minimal infrastructure requirement, and the powder product is fully compatible with current slurry coating technology for battery assembly.

Several non-limiting examples regarding various electroactive compounds made according to the current disclosure are discussed further below.

### Example

### Synthesis of Al Core and TiO₂ Shell Nanoparticles

In the current experiments aluminum powders having an initial diameter D₀ of about 50 nm were reacted using the “in situ water-shift” method described above to form core-shell nanoparticles prior to etching for various times to provide nanoparticles with different fill ratios. An annealing temperature of 450° C. in argon for 1.0 hr with a heating rate of 10° C./min was used to provide a dehydrated TiO₂ shell and convert the amorphous TiO₂ to an anatase crystal structure. Specifically, 0.05 g TiOSO₄ (reagent grade, Sigma-Aldrich) and 3.0 g H₂SO₄ (ACS grade, 1.0 N, VWR) were dissolved in 100 mL DI water. Then 0.135 g of Al powder with an average 50 nm diameter (99.9%, US Research Nanomaterials, Inc.) were added to the saturated titanium oxysulfate solution. After 30 min of vigorous agitation using an ultrasound cleaner (Symphony™, VMR), the solution was stirred for 3.0 hr-10.0 hr until the color changed from grey to a light color. Then the resultant solution was filtered to harvest the core-shell nano particles using a vacuum system and the nanoparticles were washed three times by ethanol. After drying at 70° C. for 7.0 hr in a vacuum oven (Symphony™, VMR), the sample was annealed at 450° C. for 1.0 hr in an Ar filled quartz tube furnace (Lindberg Blue M, Thermo Scientific). Finally, the sample was collected for characterization and battery testing.

### Example

### Experimental Summary

In summary, the present disclosure teaches a scalable, low-cost synthesis route for manufacturing Al/TiO₂ core-shell nano-architecture using a water based chemistry. The nano-scaled framework is composed of a solid Al core with a tunable void space, and a titanium oxide shell, which can suppress Al oxidation but does not impair electrochemical activity. The assembled half-cell used as an anode exhibited a long cycling life and an admirable rate capability. Here by making core-shell nanocomposite of aluminum core (e.g. 30 nm in diameter) and TiO₂ nanoshell (e.g. about 3 nm in thickness), with a tunable void space, 10 C charge/discharge rates with a reversible capacity exceeding 650 mAh/g after 500 cycles with a 3 mg/cm² loading was achieved. Further, at a 1 C rate, a capacity of 1237 mAh/g after 500 cycles was observed with an average Coulombic Efficiency of about 99.2% after 500 cycles. Moreover, owing to the high ion/electron conductivity of Al and TiO₂, a capacity of 661 mAh/g after 500 cycles at a fast rate of 10 C still remained implying a potential application in electric vehicles.

### Example

### Characterization Techniques

X-ray diffraction (XRD) measurements were carried out via a Bruker D8-Advance diffractometer using Ni filtered Cu Kα radiation. The applied current and voltage were 40 mA and 40 kV, respectively. During the analysis, samples were scanned from 10° to 70° at a speed of 4°/min. SEM images were collected on a FEI Sirion scanning electron microscope (accelerating voltage 5 kV) equipped with energy-dispersive X-ray spectroscopy and TEM images were taken on a JEOL JEM-2010 transmission electron microscope operated at 200 kV. TG-DSC analysis was performed using Netzsch STA 449 with air flow at a heating rate of 10° C./min from room temperature to 600° C. Inductively coupled plasma mass spectrometry (ICP-MS) was carried out using a Thermo Scientific ICAP 6300 Duo View Spectrometer.

### Example

### Al Core TiO₂ Shell Particles

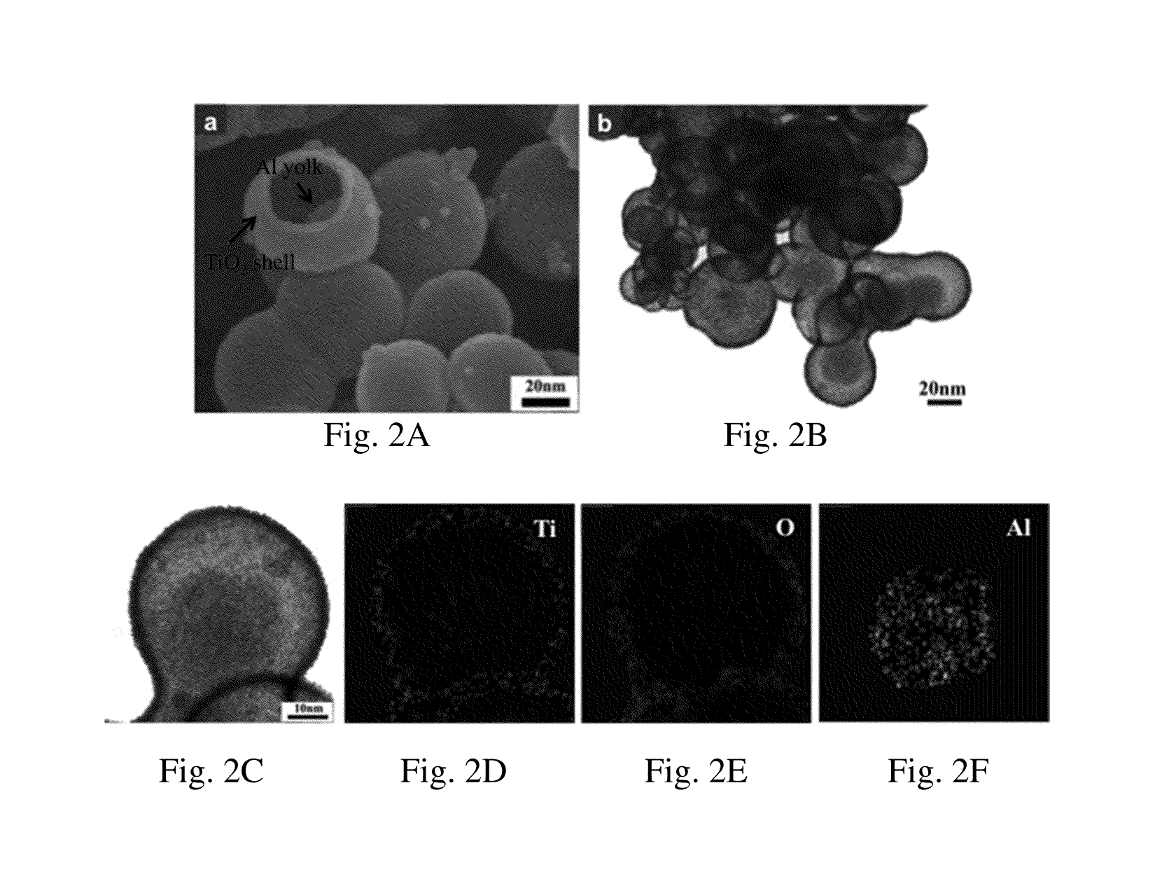

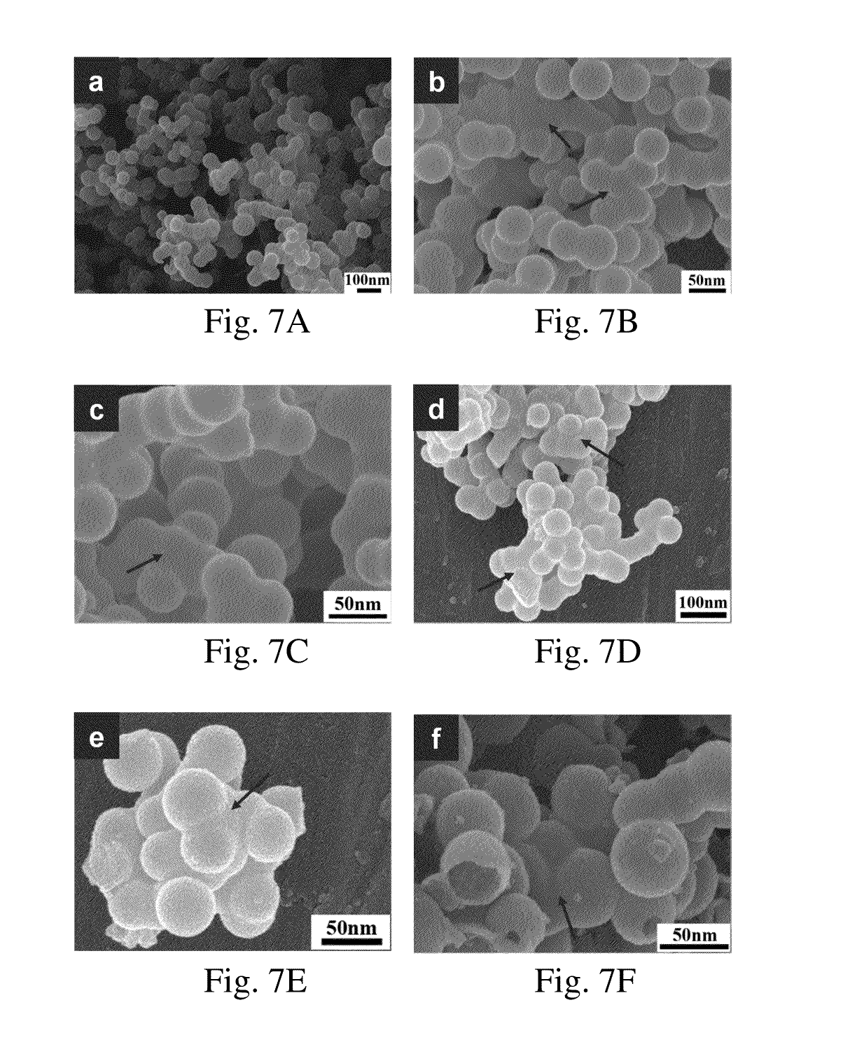

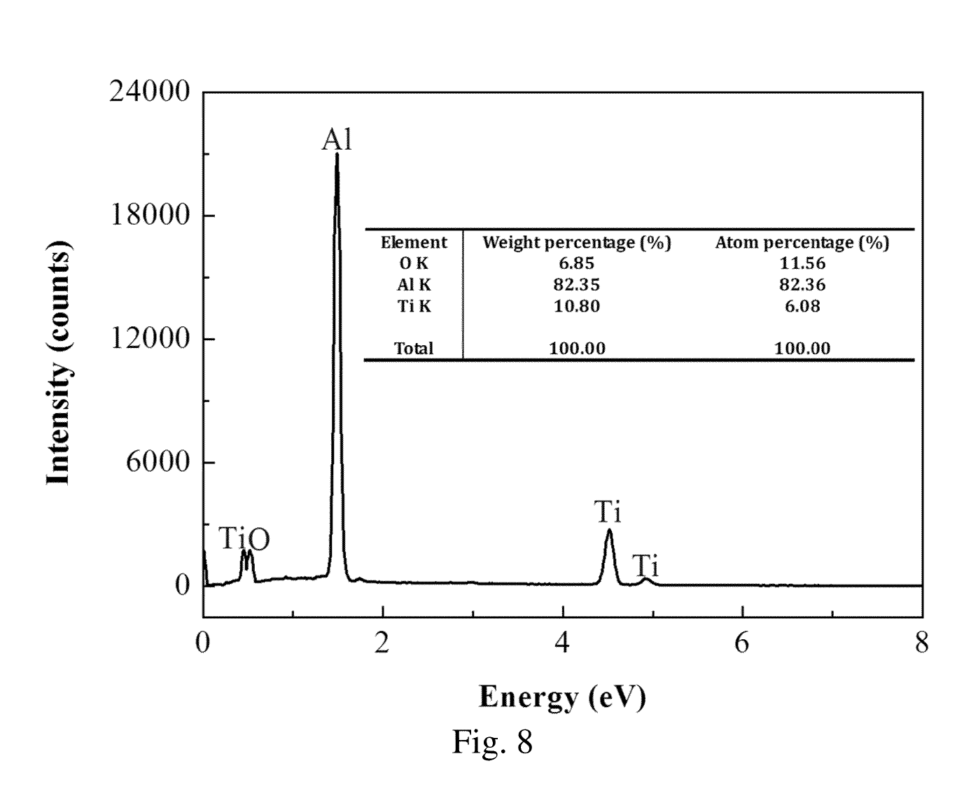

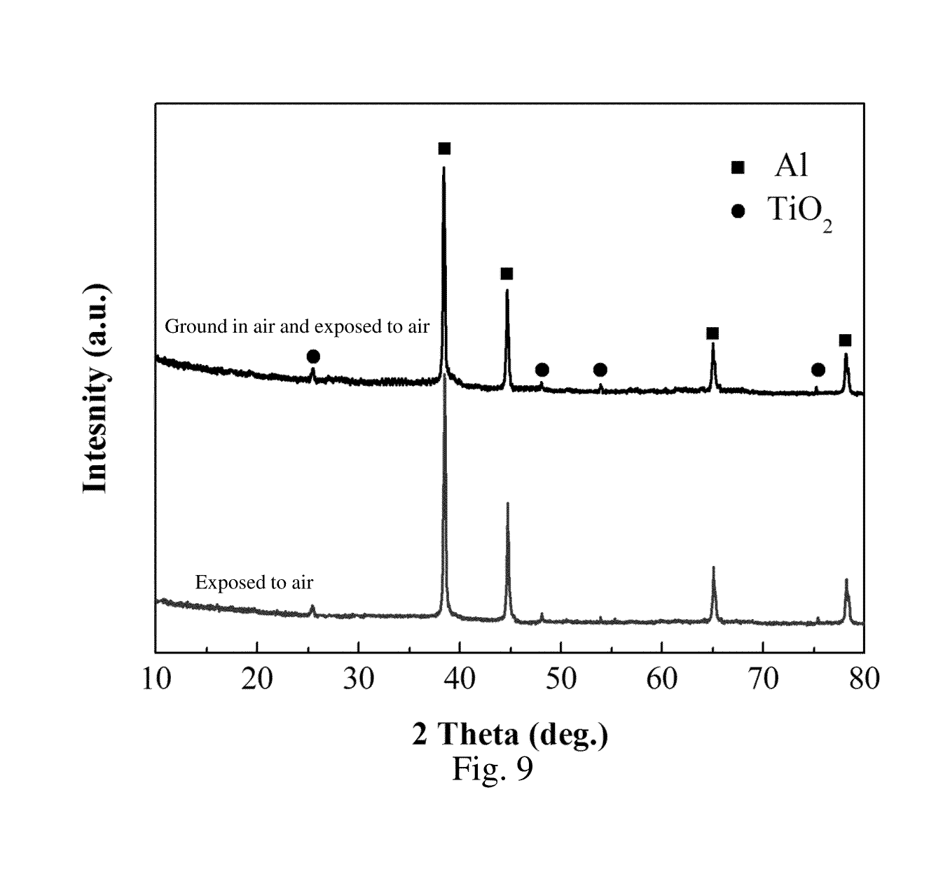

FIG. 2a shows an SEM image of the as-obtained Al core and TiO2 shell nanoparticles for an etch time of t_{etch}=4.5 hr, which clearly reveals a solid core encapsulated by a nearly spherical shell (arrows). However, it is worth mentioning that the starting aluminum nanoparticles often stick together even after sonication, and so double-cores enclosed in a single-shell or even multiple-cores enclosed in a single-shell are also obtained after reacting with acid (see FIGS. 7A-7F), but these multiple core nanoparticles do not seem to degrade the performance much. Energy-dispersive X-ray spectrum (FIG. 8) of the nanostructure shown in FIG. 7A demonstrates the presence of Al and TiO₂. Separate TEM results indicate a complete coverage of the Al core by the TiO₂ shell (FIGS. 2A-2C). Without wishing to be bound by theory, it is believed that the shell blocks electrolyte convection which limits SEI formation to the outer shell surface. Inside, aluminum nanoparticles, about d=30-35 nm in diameter, are encapsulated by the TiO₂ shell, with a well-defined void space in between that can accommodate the volume expansion of the aluminum core during lithium cycling. The TiO₂ shell, although only a few nanometers thick, was able to support the core and effectively protect the chemically active aluminum as shown by the x-ray diffraction peaks shown in FIG. 9. Thus, these results confirm that the TiO₂ shell: protects the as-formed fresh aluminum particles forming the core; conduct electrolyte and ions to the core, and act as an electrolyte blocking layer to limit SEI formation to outside the shell. The element maps of a core shell nanoparticle shown in FIGS. 2D-2F further confirm the core-shell characteristic with aluminum as the core, TiO₂ as the shell, and a void space in between.

### Example

### Varying Etching Time

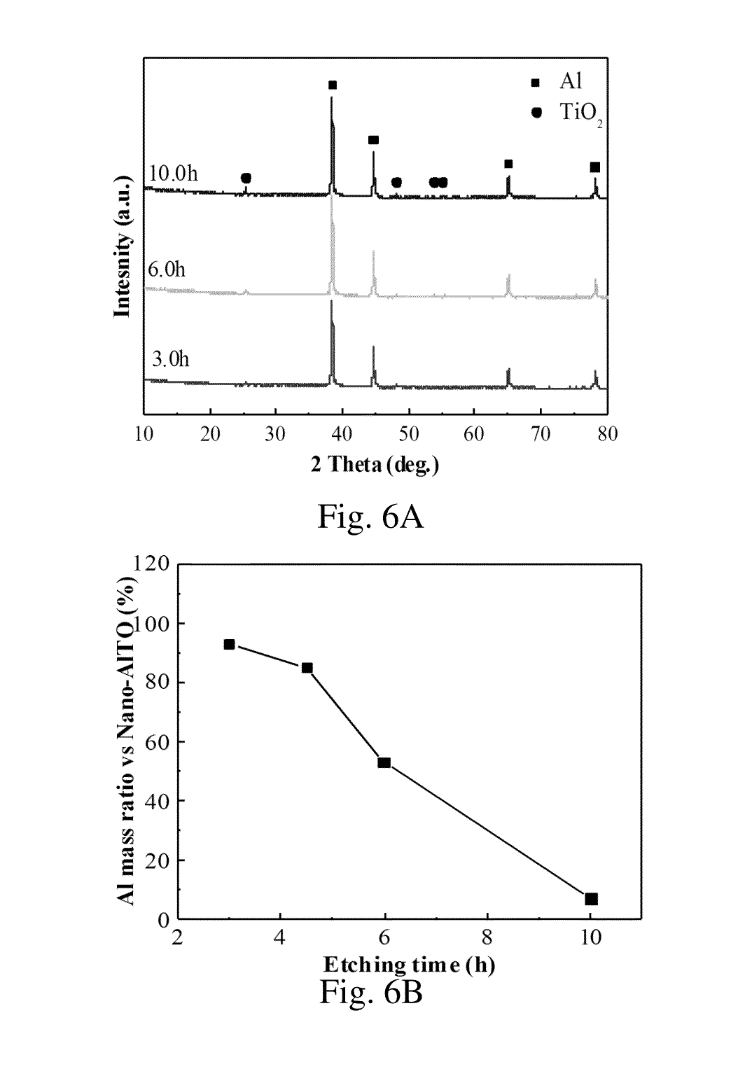

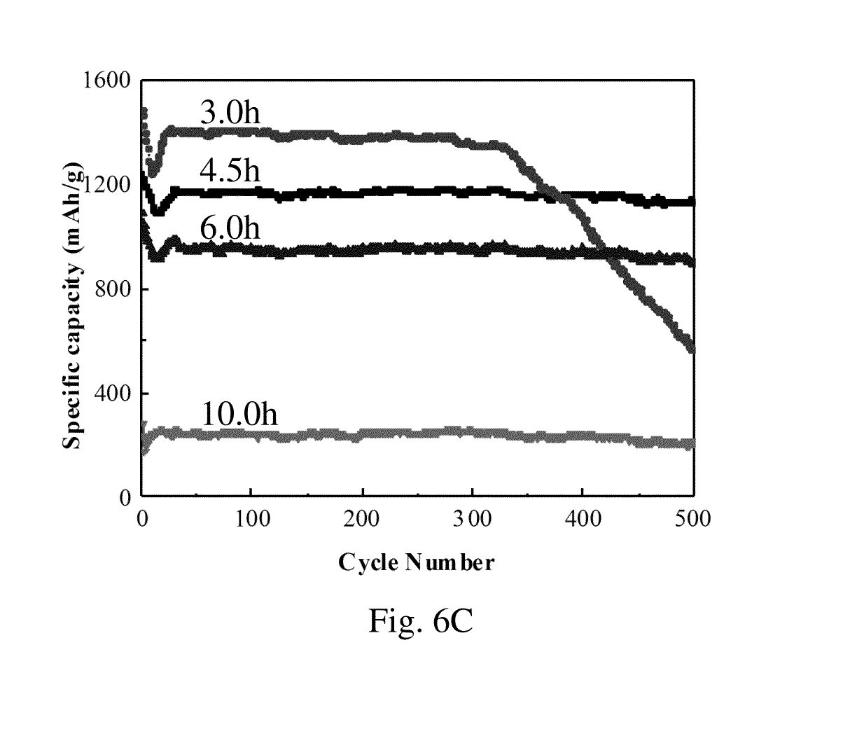

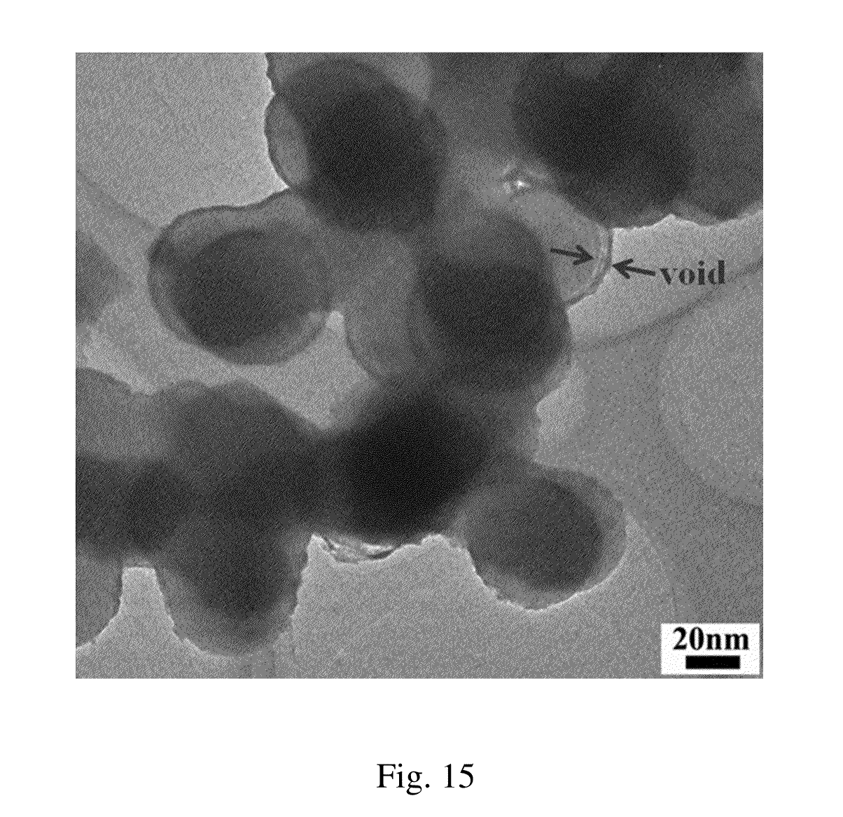

As noted above, the void space located between a core and the enclosing shell may be adjusted by controlling the wet reaction or etching time t_{etch}. Again this may be desirable because optimizing the internal void space balances the expansion of the core during cycling with diffusion and storage capacity of the core. To explore the experimental parameters, core-shell nanoparticles were synthesized with different etch times t_{etch}. FIG. 1B and FIG. 6A illustrate the XRD patterns of samples with different etching times. From the patterns, it is observed that the original Al₂O₃ layer is completely eliminated and the final product consists of pure aluminum and anatase, which also indicates that the outer TiO₂ shell was able to protect inner Al from being oxidized in air because no Al₂O₃ peaks were observed. FIG. 6B provides the aluminum weight percentage for samples subjected to different etching times as determined by inductively coupled plasma (ICP) analysis, and FIG. 6C shows the corresponding specific capacity at a 1 C rate for the materials subjected to different etch times. Overall, for samples with such high aluminum percentage (85 wt %), a remarkable battery performance is observed. For t_{etch}=3.0 hr, the capacity is as high as 1400 mAh/g at 1 C after 300 cycles. However, severe capacity fade for the nanoparticles etched for 3.0 hr was observed after 300 cycles, which is believed to be due to the insufficient void space to fully accommodate the core with a fill factor of about 2, see FIG. 6C and FIG. 15. Therefore, after hundreds of cycles, the Al—Li core will rupture the TiO₂ shell which then subjects the core to repeated unstable SEI formation. In contrast, for the sample with longer etch times t_{etch} of about 4.5 hr, the initial reversible capacity is a little bit lower than that for the 3 hr etch time due to a smaller core-to-shell weight ratio, but the performance is ultra-stable during the whole 500 cycles shown in the figure, illustrating the compromise between transport and mechanical considerations in the electroactive material design. Comparing the four results, the optimal t_{etch} for the current process was determined to be about 4.5 hr, corresponding to a core diameter d of about 30 nm to 35 nm and a shell diameter D₀ of about 47 nm as measured from TEM. This corresponds to a fill factor B ranging from about B=2.4 to 3.8. While particular etch times are described above, it should be understood that appropriate etch times will vary based on temperature, particle size, desired material properties, acid bath strength, and other appropriate variables. Therefore, other etch times for different formation processes are also contemplated.

### Example

### Half-Cell Battery Performance of Al Core and TiO₂ Shell Nanoparticles

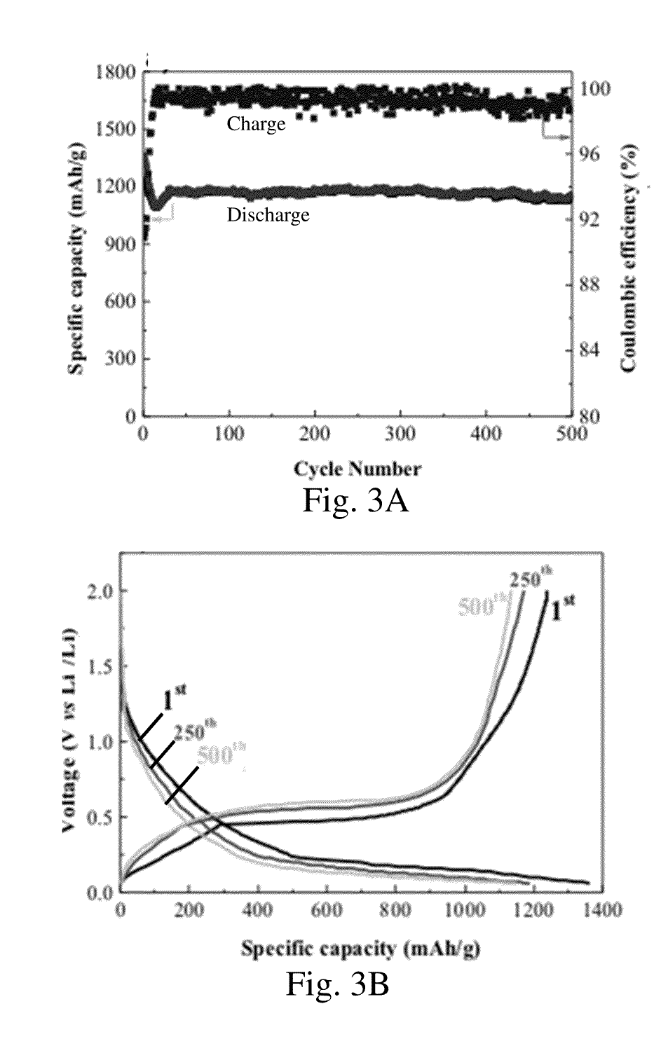

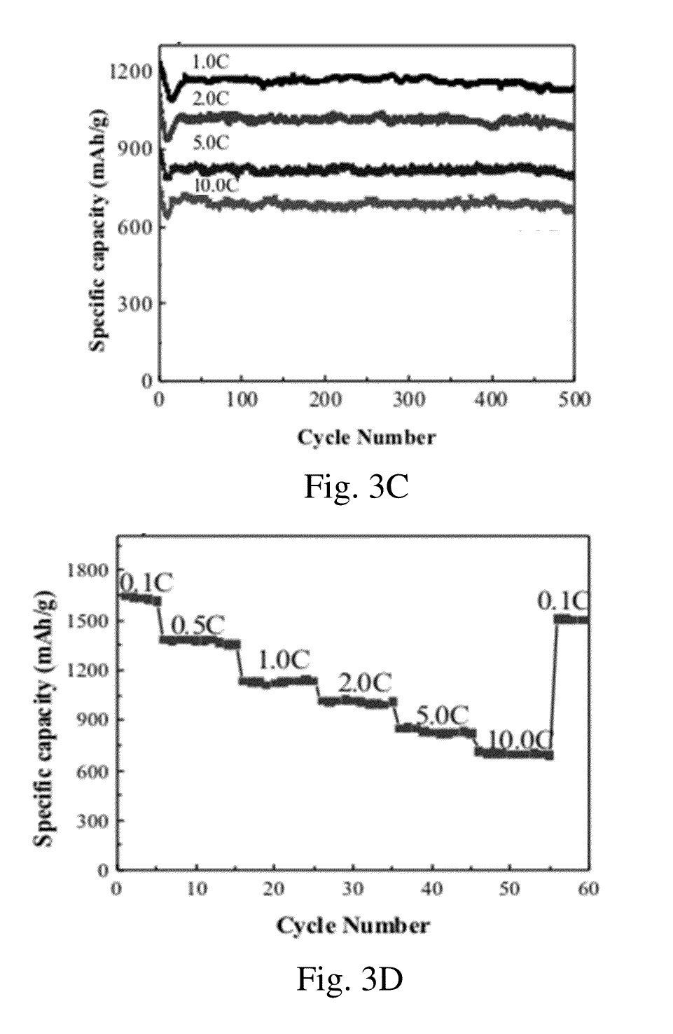

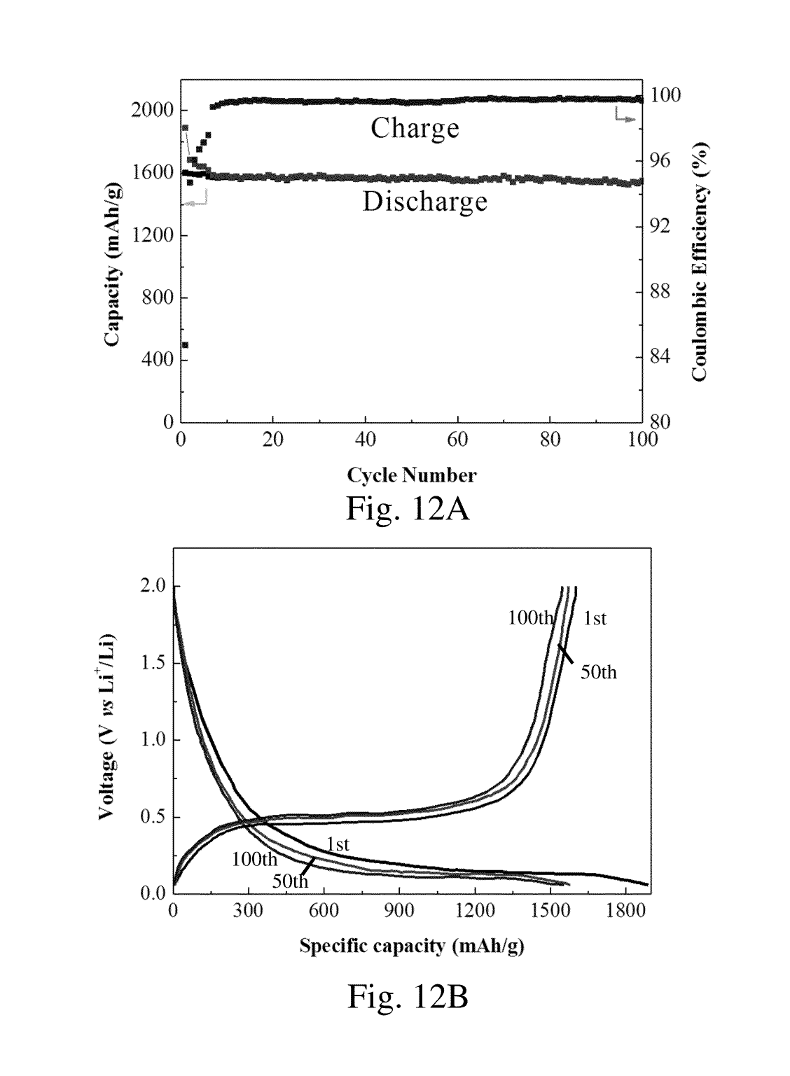

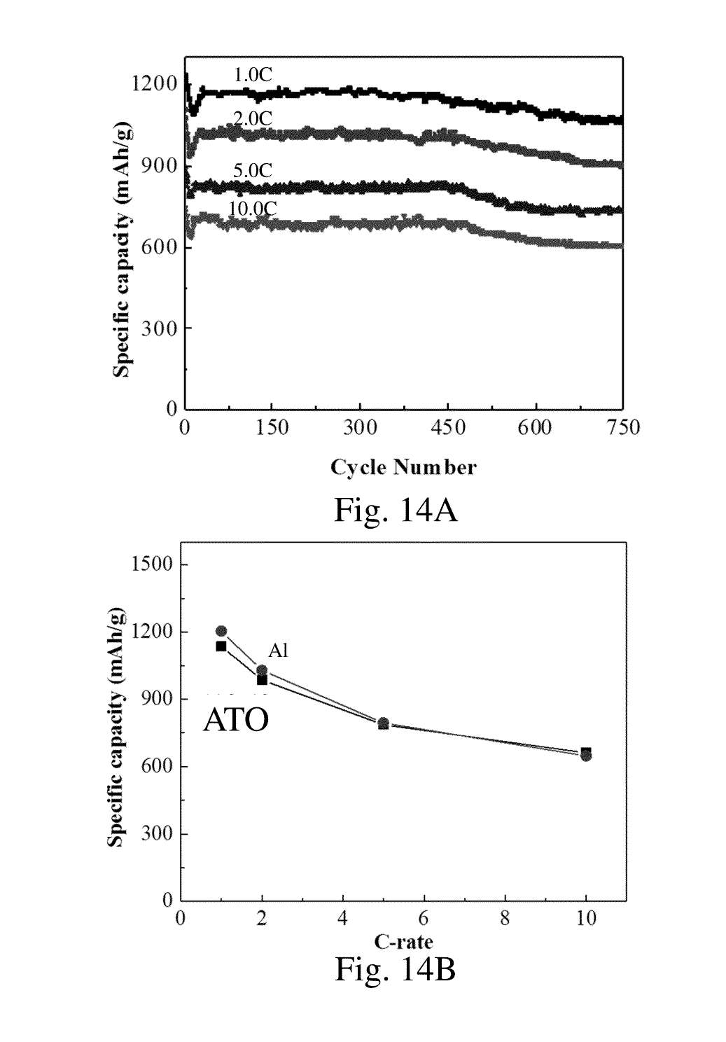

The tested Al core and TiO₂ shell nanocomposites (ATO) exhibit remarkable battery performance. As shown in FIG. 3A, at a rate of 1 C, the first discharge and charge capacities are 1237 and 1360 mAh/g, respectively, which indicate a first-cycle Coulombic Efficiency of 90.9%. Without wishing to be bound by theory, the 9.1% unbalanced charge-discharge electrons, or “AWOL electrons”, in the first cycle mostly likely reflect the asymmetric formation of SEIs covering the two electrodes. Then, the specific capacity stabilizes at 1170 mAh/g in later cycles. Importantly, the Al core and TiO₂ shell powders have long cycle life and the capacity decay is less than 0.01% per cycle. The average Coulombic Efficiency is 99.2% during the first 500 cycles. The voltage profiles for the different cycles are shown in FIG. 3B. The shape of the profile does not change significantly from the 250^{th} to the 500^{th} cycle, indicating ultra-stable performance. At a rate of 10 C, the Al core and TiO₂ shell electrode can still achieve a capacity of 661 mAh/g after 500 cycles, two times that of the theoretical capacity of graphite as shown in FIGS. 3C and 3D. We believe the excellent rate performance of ATO is due to Aluminum's good electrical conductivity, which is an advantage over Silicon as the active material. This high performance persists to at least 750 cycles (see FIG. 14A), even though faster capacity decay (about 0.03%/cycle) appeared after the 500^{th} cycle or so. Given that the SEI layer may exhibit time-dependent growth, a slow cycling rate of 0.1 C was checked, as shown in FIGS. 12A-12B, and an even higher reversible capacity of 1599 mAh/g was achieved for 100 cycles.

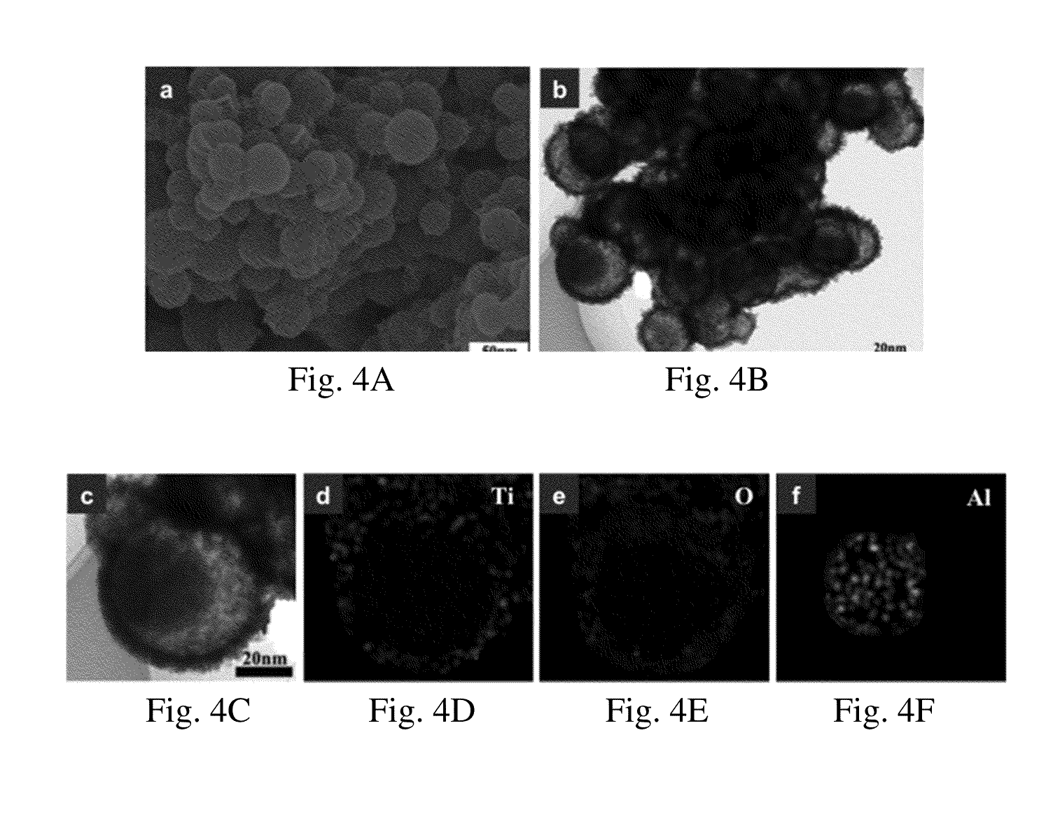

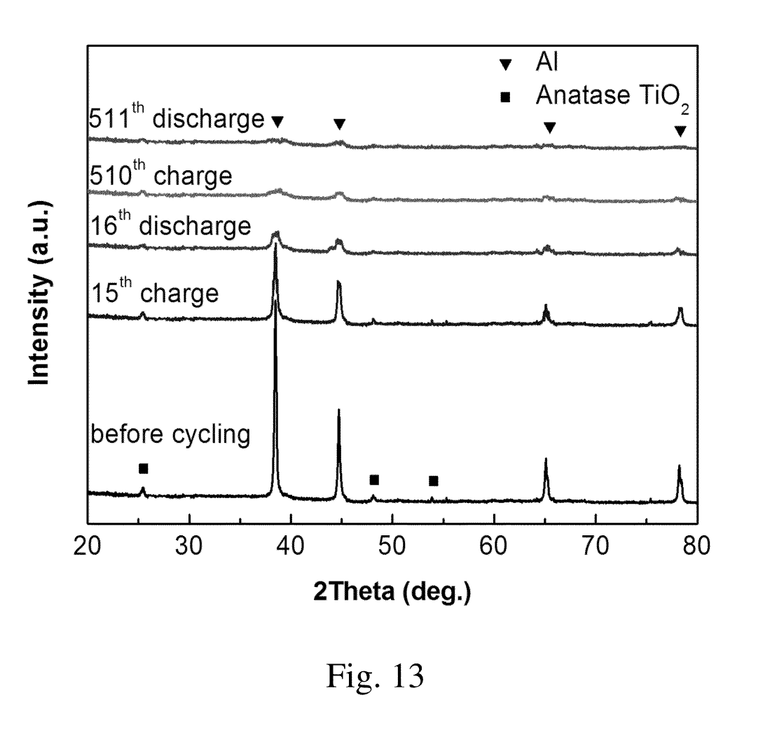

To characterize the anode morphology evolution after cycling, a coin cell was opened after 500 cycles. The Al core and TiO₂ shell nanoparticle anode was washed in acetonitrile to remove the electrolyte and rinsed with ethanol 3 times. FIGS. 4A-4F show the structure of Al core and TiO₂ shell nanoparticles after 500 charge-discharge cycles. As illustrated in the figures, the core-shell stays intact even after 500 cycles, which explains the good cyclability. The shell's outer surface becomes thicker and rougher after the battery test, indicating the formation of the SEI layer on the TiO₂ shell when compared to the as formed material shown in FIGS. 2A-2F. The electrochemical stability window of the ethylene carbonate-diethyl carbonate electrolyte used in this study is 1.3-4.5 V vs. Li⁺/Li, so SEI will form when the cycling voltage drops below 1.3 V. The elemental mapping in FIG. 4D-4F also reveal a perfect Al core TiO₂ shell structure even after 500 cycles, and therefore it can be concluded that the void between the core and shell has successfully accommodated the volume expansion/shrinkage during the many cycles while also remaining fully enclosed due to the lack of observation of SEI debris filling the inside of the cavity from reactions between the electrolyte and aluminum core as would be expected for other Al-based anodes. To be able to cycle 500 times with a pristine interior surface means the shell integrity is excellent. FIG. 13 shows the XRD pattern of Al core and TiO₂ shell anode at 0^{th}, 15^{th}, 16^{th}, 510^{th}, and 511^{th} cycle. Compared with the initial crystalline Al face centered cubic (FCC) structure, the nanoaluminum core inside the TiO₂ shell has turned amorphous. In the literature, elemental metals tens of nanometers in domain size have turned amorphous under rapid temperature quenching. Without wishing to be bound by theory, it is believed that electrochemical shock could have similar effect of solid-state amorphization on the aluminum core.

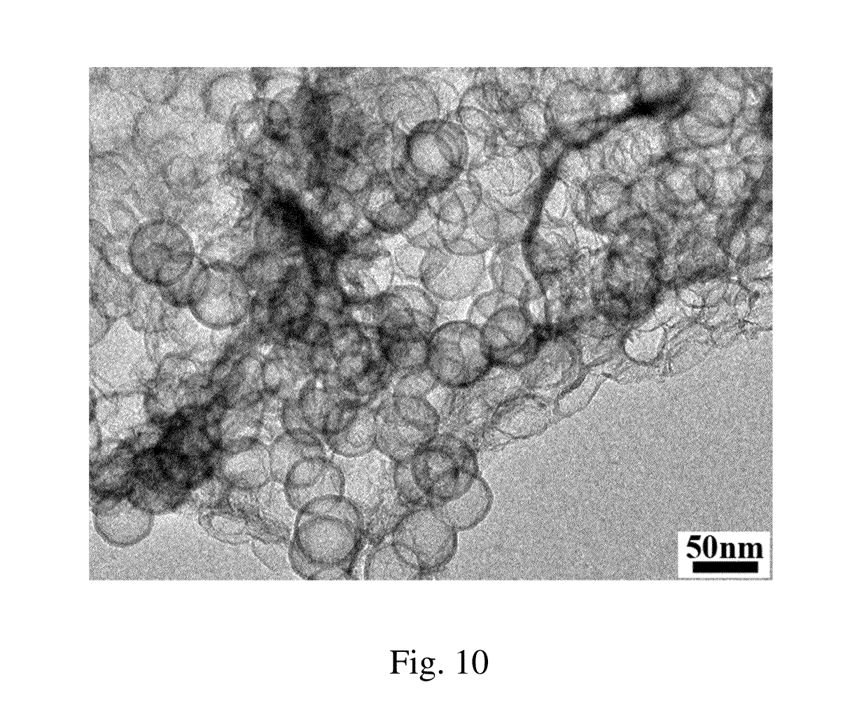

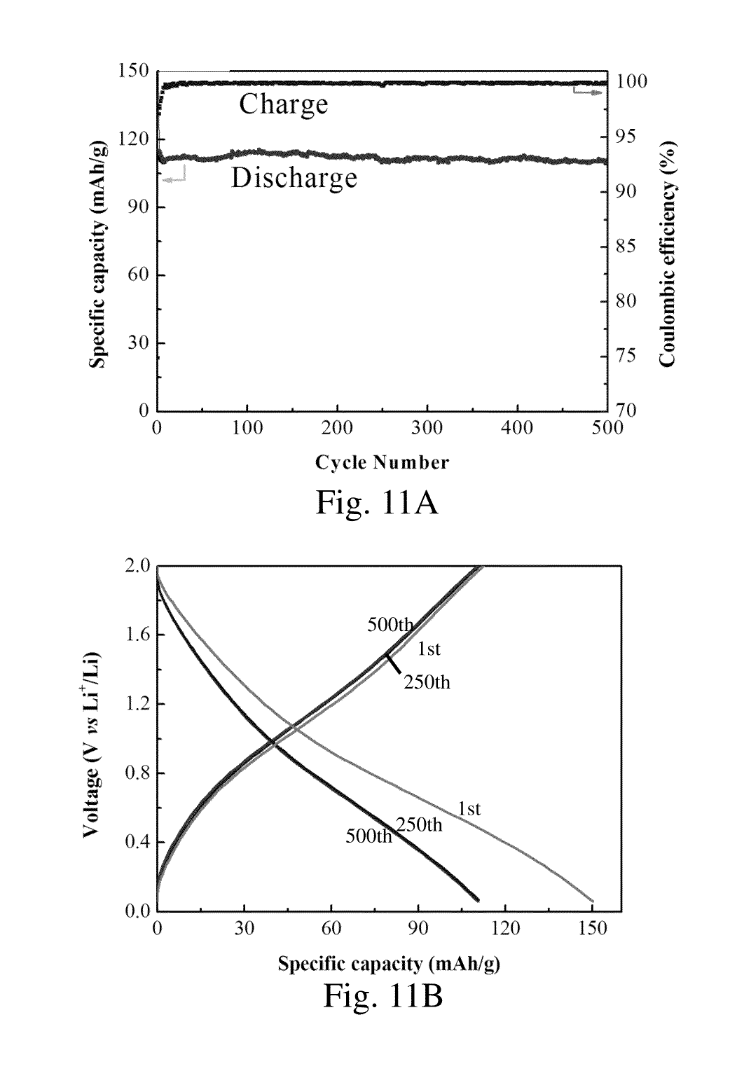

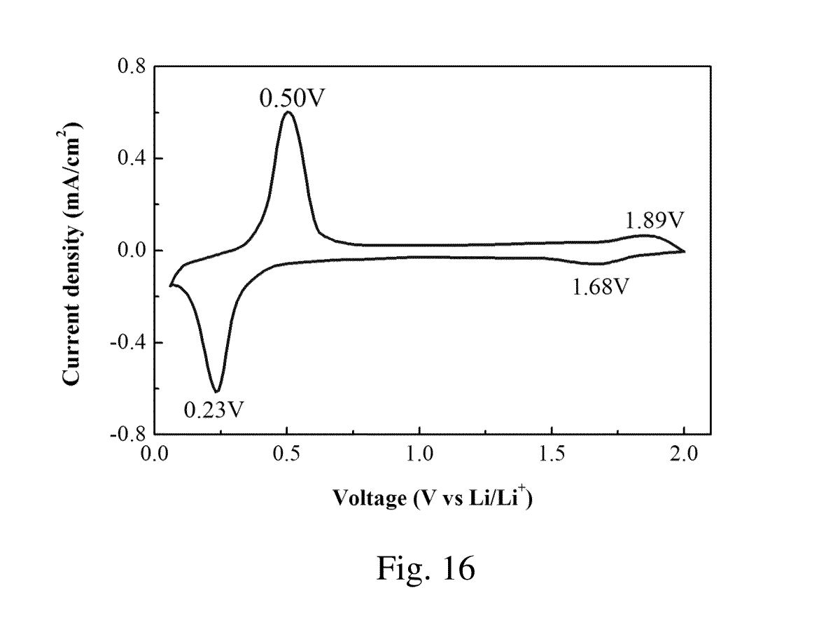

Cyclic voltammetry (CV) was performed on ATO (FIG. 16). During the cathodic scan, the cell displayed a well-defined peak potential at 0.23 V and a prominent peak potential at 0.50 V was observed in the anodic sweep, which correspond to the discharging and charging plateau observed in FIG. 3B, respectively, representing the alloying/dealloying of aluminum. Meanwhile, one pair of broad cathodic/anodic peaks (located at 1.68 and 1.89 V) corresponding to Li-insertion/extraction in TiO₂ were also detected, suggesting a pseudocapacitor-like characteristic of the TiO₂ shells during lithiation and delithiation. For the sake of comparison, completely hollow TiO₂ (without Al) was synthesized using an etching time of 24.0 hr (FIG. 10) and its cycling performance at 1 C was also characterized (FIGS. 11A-11B). The reversible capacity of hollow TiO₂ particles was 112 mAh/g for the first cycle and stabilized at 111 mAh/g for later cycles. Moreover, it is interesting to find that the hollow TiO₂ nanoshells exhibit a quasi-linear voltage-capacity response (instead of a voltage plateau) during galvanostatic charging-discharging, consistent with the broad CV peaks at 1.68 and 1.89 V. It is believed that the reason for such pseudocapacitive behavior is that when the TiO₂ shell (about 3 nm thick) is extremely thin, a large fraction of lithium storage sites are on the surface or in near-surface regions. After deducting the TiO₂ contribution, the specific capacity of the composite materials due to the nanoaluminum cores was calculated to be 1246 mAh/g as measured at a 1 C rate.

### Example

### Full-Cell Battery Performance of Al Core and TiO2 Shell Nanoparticles

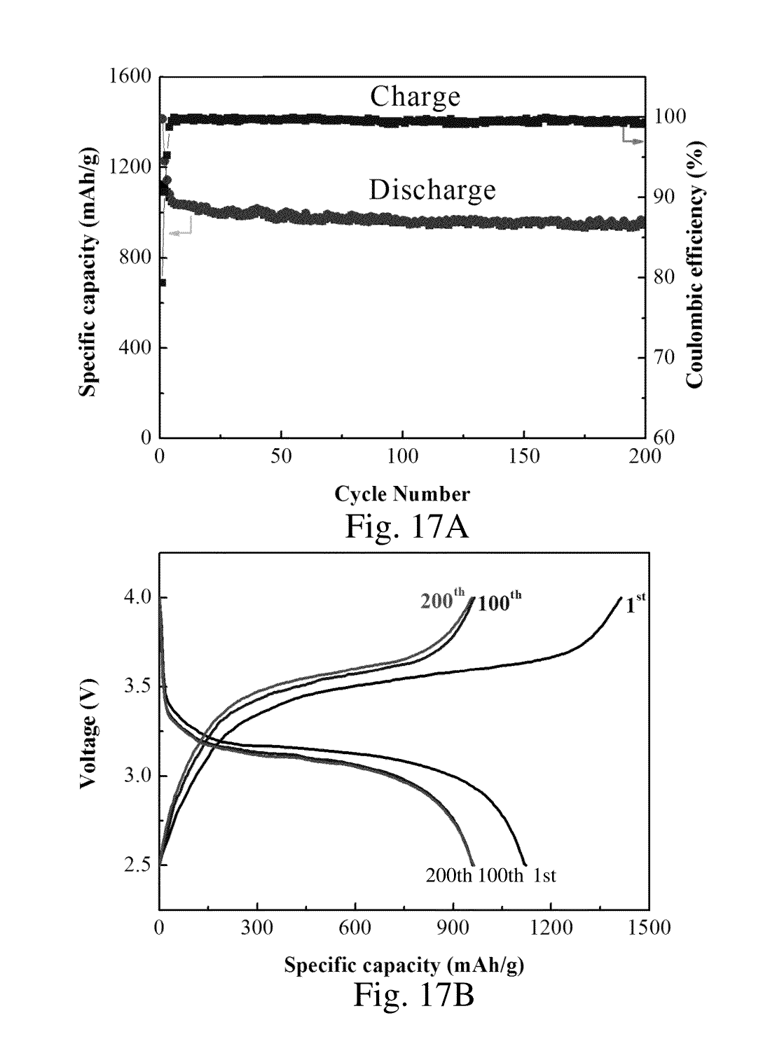

All the tests above were performed with half-cells, where the counter-electrode used was lithium metal with super-abundant moles of lithium (about 1000%) relative to the ATO capacity. However, half-cell tests are known to be an unreliable check of failure due to expansion of the core. Passing the more rigorous full-cell tests, where one uses a lithium-molar-matched counter-electrode, would certify ATO as being close to practical use. Therefore, full cells were fabricated with an ATO anode, and LiFePO₄ (LFP) cathode with only 35% more lithium relative to the ATO capacity in half cells. The fact that metallic lithium foil is no longer used, which served both as an abundant Li ion source and as a reference electrode with little potential change upon lithiation/delithiation, critically tests the applicability of ATO in a real-world context. Even after including all lithium ions contained in the electrolyte salt, the total lithium contained in the full cells does not exceed roughly 150% of the ATO capacity. FIGS. 17A and 17B show that the full cell exhibited a first discharge capacity of 1123 mAh (g of ATO)⁻¹ at a rate of 1 C over a voltage range of 2.5 to 4.0 V, with a first-cycle Coulombic Efficiency equal to 79.4%. This means in the first cycle, greater than 20%, within the roughly 50% excess, lithium was used to form initial SEI that cover the large surface area of the Al core and TiO₂ shell nanoparticles. This initial SEI formation using excess lithium is a normal and common treatment in all commercial batteries. The key is from the 2^{nd} cycle on, whether the remaining roughly 30% excess lithium is sufficient to sustain a large number of cycles. FIGS. 17A and 17B show that the 30% excess lithium is indeed sufficient to provide long term cyclability with the specific capacity stabilizing at about 968 mAh (g of ATO)⁻¹ for at least up to 200 cycles in the full cell. This proves that the TiO₂ shells are indeed robust enough that a great majority of the Al core and TiO₂ shells survive, and that the SEI is stable outside of the TiO₂ shell.

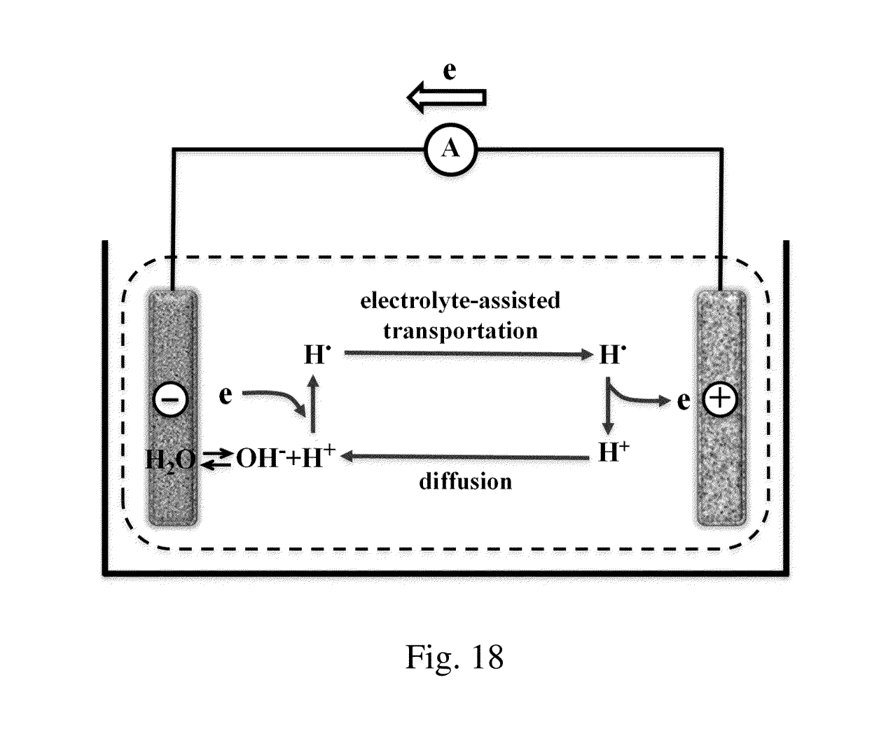

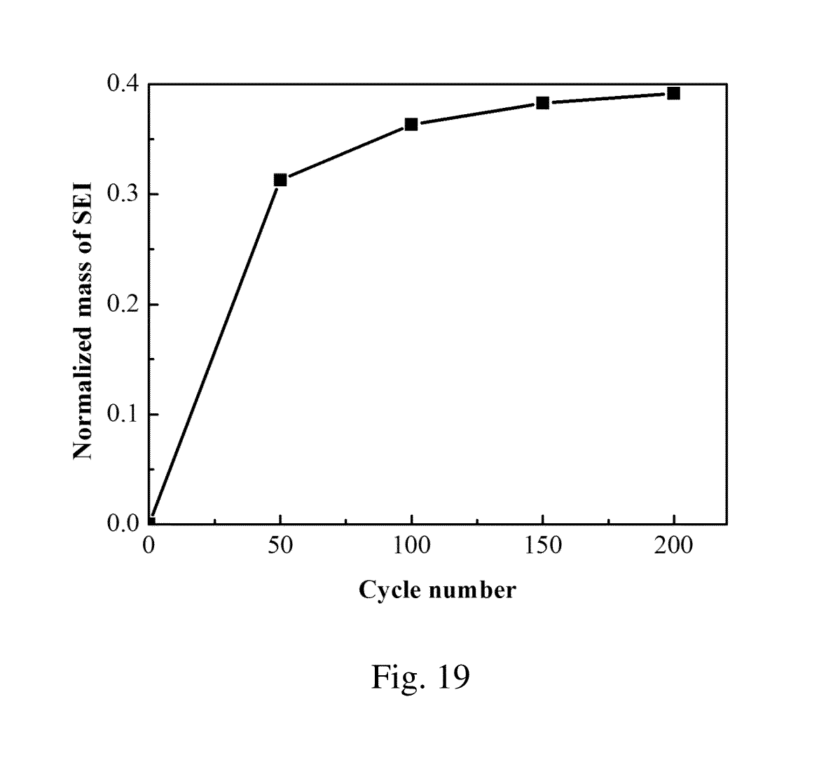

Curiously, the full-cell tests showed an average Coulombic Efficiency of only 99.48% from the 2^{nd} to 200^{th} cycles. Even though the ATO's Coulombic Efficiencies in half-cell and full-cell tests are actually very good compared to most of the high-capacity electrodes known in the literature, it seems to violate a commonly held belief of the battery industry that Columbic Efficiency should exceed 99.9% to be able to cycle 200 times, since (0.999)²⁰⁰=0.82, and 80% capacity retention is a typical definition of end of battery life. These full-cell tests prove that Coulombic Efficiency does not have to be greater than 99.9% in order for lithium-matched full cells to cycle two hundred times. It is believed that this is because the unbalanced charge-discharge electrons (AWOL electrons) do not all tie down Lithium irreversibly. Here, it is believed that the 0.52% AWOL electrons are not all generating irreversible SEI, but instead form a reversible redox shuttle inside the electrolyte, as illustrated in FIG. 18. The reversible redox shuttle is likely water-related because it is hard to make the ATO completely dry in the current experimental setup. A possible chemical mechanism involving hydrogen radical transport is illustrated in the figure. To double check the proposed mechanism, direct estimates of the total mass of SEI on ATO was measured by measuring the mass of an ATO based anode after 50, 100, 150 and 200 cycles. From these measurements, there is only about a 40% mass increase relative to the initial ATO weight (without binder and carbon black) after 200 full-cell cycles as shown in FIG. 19 and unlike previous Al-based anodes the SEI debris does not bury the Al.

### Example

### ATO Comparison

ATO is contrasted with several existing anode technologies below. For example, compared to metallic lithium based materials, ATO does not form dendrites at a high rate and is less of a safety concern because of air stability. Also, as compared to Si core C shell nanoparticles, ATO has about a 20% lower capacity at a 1 C rate, but provides higher capacity with long cycle life above a 1 C rate. Compared to a high-rate Li₄Ti₅O₁₂ anode which has extremely long cycle life, ATO has 8 times the gravimetric capacity at a 1 C rate, and a much better (i.e. lower) operating voltage range. Compared to conventional graphite anodes (theoretical capacity 372 mAh/g) used in current batteries, ATO has similar voltage characteristics, but has 4 times the gravimetric capacity at a 1 C charge/discharge rate. The fact that ATO achieves 10 C charge/discharge rate with reversible capacity exceeding 650 mAh/g even after 500 cycles makes it a high-rate and ultrahigh-capacity anode, at an industrially satisfactory loading of 3 mg/cm². These comparisons, along with the current simple scalable synthesis method, confirm that ATO is suitable for use in electrochemical devices.

### Example

### Electrochemical Testing

The battery performance of Al core and TiO₂ shell nanoparticles (ATO) as an anode material was measured using a coin cell (CR2032, Panasonic). The ATO electrode was prepared by mixing 70 wt % of the Al core and TiO₂ shell nanoparticles, 15 wt % conductive carbon black (Super C65, Timcal), and 15 wt % poly(vinylidene fluoride) binder (Sigma-Aldrich) in N-methyl-2-pyrrolidinone solvent (Sigma-Aldrich). The obtained slurry was coated onto copper foil with a loading of 3 mg/cm² of Al core and TiO₂ shell nanoparticles and dried at 65° C. for 24.0 hr. The half coin cell was made using a Li foil as a counter and reference electrode and was assembled in a glove box (Labmaster sp, MBraun) filled with argon. To suppress lithium dendrite formation and also improve the cycle performance of the lithium foil in the half-cell arrangement, a Li₃N passivation layer was coated on the lithium foil electrode before battery assembly. The pretreatment procedure exposes one face of a fresh Li foil (thickness about 600 μm) to flowing N₂ gas at a constant velocity for 2 hr at room temperature to form Li₃N. When preparing the half-cell, the pretreated side of lithium foil was placed in contact with the electrolyte. A hydraulic crimping machine (MSK-110, MTI) was used to close the cell. The electrolyte was 1.0 M LiPF₆ dissolved in 1:1 (volume) ethylene carbonate and diethyl carbonate, and a microporous polyethylene film (Celgard 2400) was used as the separator.

The assembled cell was cycled between 0.06 to 2.0 V at various rates ranging from 0.1 C to 10 C using a LAND 2001 CT battery tester. All of the specific capacities were calculated on the basis of total mass of Al core and TiO₂ shell nanoparticle except the data in Table 1 and FIG. 14B were based on pure aluminum. The C rate was calculated on the basis of the theoretical capacity 1410 mAh/g of Li₃Al₂. The cyclic voltammetry curves were obtained at room temperature using the described coin cells using voltages between 0.06 and 2 V at a scan rate of 0.1 mV/s.

Full cells consisting of ATO as the anode, LiFePO₄ (LFP) as the cathode, and a 1M LiPF₆ EC:DEC 1:1 solution as the electrolyte were also fabricated and tested. The ATO anode was prepared using the same methods described above and the electrode film was punched into discs with diameters of 10 mm before battery assembly in a glove box filled with argon gas. The LFP electrodes were fabricated by spreading the mixture of LFP (Pulead Technology Industry Co., Ltd.), carbon black (Super C65, Timcal) and poly(vinylidene fluoride) binder (Sigma-Aldrich) with a weight ratio of 80:10:10 onto Al current collectors. The electrode was pressed under 6-10 MPa and punched into 11 mm diameter circular disks. The active material loading was 1.3 mg/cm² for the ATO anode and 10.5 mg/cm² for the LFP cathode. The mass of ATO, LFP and even the Lithium salt in the electrolyte was carefully calculated/weighed, and the total lithium contained in the full cells did not exceed about 150% of the ATO capacity in the half-cell configuration. The matched ATO/LFP full cells were evaluated by galvanostatic cycling in a 2032 coin-type cell over a 2.5 V-4.0 V range at a 1 C-rate (1410 mA g⁻¹ of ATO). The mass of SEI layers was estimated by measuring the mass of ATO active material based anode before and after 50, 100, 150 and 200 cycles. The normalized mass of SEI is defined as the ratio of the mass gain on ATO after cycling (presumably due to SEI layers covering ATO) to the initial ATO mass loaded in the cell without SEI. Two LFP/ATO full cells were used for the average normalized mass of SEI for each cycling condition.

Table 1 provides a comparison of battery performance for ATO as an anode material in Li-ion batteries to other aluminum based electroactive materials. As noted above, the capacity was calculated based on the mass of aluminum.

TABLE 1

| | 1st | Reversible | | | | | |
|---|---|---|---|---|---|---|---|
| | discharge | discharge | | Charge/ | Total | Degradation | Potential |
| | capacity | capacity | | discharge | cycle | rate per | range |
| Material | (mAh/g) | (mAh/g) | | rate (A/g) | No. | cycle | (vs Li⁺/Li) |
| Al—C hybrid | 1680 | 922 | (100^{th}) | 6.0 | 100 | 0.60% | 0.01-3 V |
| nanocluster | | | | | | | |
| Free-standing | 1200 | 100 | (10^{th}) | 0.7 | 10 | 22.00% | 0.01-3 V |
| Al | | | | | | | |
| Bulk Al | 1390 | 800 | (1^{st}) | 0.25 | 1 | 42.40% | 0.01-1.2 V |
| Nano-LiAl | 977 | <200 | (25^{th}) | ~1.0 | 25 | >6.0% | 0.01-1 V |
| ATO | 1468 | 1246 | (500^{th}) | 1.4 | 500 | 0.01% | 0.06-2 V |
| | | 1205 | (750^{th}) | (1.0 C vs | 750 | 0.03% | |
| | | | | Al₂Li₃) | | | |

### Examples

### Additional Material Properties

To select an appropriate annealing temperature for an Al core and TiO₂ shell nanoparticle, TG-DSC analysis was carried out. As shown in FIG. 5, first the sample went through a dehydration process, displaying a loss of about 6 wt % at 100-300° C. Then a negligible weight loss was observed along with two exothermic and one endothermic peaks, which correspond to amorphous to anatase (395° C.), anatase to rutile (560° C.) TiO₂ phase transformation, and aluminum melting (480° C.), respectively. For the purpose of obtaining crystal anatase TiO₂, an annealing temperature of 450° C. was used.

FIG. 6A shows XRD patterns of Al core and TiO₂ shell nanoparticles for different etching times of 3.0 hr, 6.0 h, and 10.0 hr. It can be seen from the observed XRD peaks that the final product only consisted of pure aluminum and anatase TiO₂. Apparently the native Al₂O₃ layer was fully replaced by TiO₂ at an etching time between 3.0 to 10.0 hr. As noted above, the reaction time mainly affects the size of interstitial space via dissolving the aluminum core. FIG. 6B shows the aluminum concentration dependence on etching time. A shorter 3.0 hr treatment enables a high aluminum concentration of greater than 93 wt %, which indicates a small void space volume as shown in FIG. 15. Specifically, the void space volume was estimated to be about 30% of the volume of the aluminum core, which is not enough to accommodate aluminum's roughly 96% volume expansion during lithiation. As a result, the TiO₂ shell for the 3 hr etch material was possibly damaged during cycling and thus exhibited the observed fast capacity decay shown in FIG. 6C after 300 cycles. However, longer etching times provided a bigger void space, which lead to better accommodation of the core expansion and cyclability as also shown in the figure. It is noted thought that a lower aluminum ratio associated with the longer etching times (about 53 wt % with a 6.0 hr etch and about 7 wt % with a 10.0 hr etch) results in a lower specific capacity, which was calculated using the total mass of Al core and TiO₂ shell nanoparticles, see FIG. 6B. At the same time, a larger void space reduces conductivity because of the loose contact between the core and enclosing shell, leading to higher impedance. The Al core and TiO2 shell nanoparticles etched for 6.0 hr and 10.0 hr have specific capacities of about 903 mAh/g and about 209 mAh/g after 500 cycles, respectively. For these processing parameters, the sample with about 85 wt % Al from the 4.5 hr etch time exhibited a desirable combination of properties in cyclability, capacity, and rate capabilities that offer a good balance of capacity and cyclability for battery performance.

### Examples

### Multiple Cores

FIGS. 7A-7F show the double-core-single-shell and multiple-core-single-shell structures caused by insufficient sonication and nanoparticle dispersal in acid. Energy-dispersive X-ray spectrum, see FIG. 8 of the nanostructure in FIG. 7A demonstrates the presence of Al and TiO₂. The inset table shows that the weight fraction of Al is greater than 80%, which is also consistent with the ICP results shown in FIG. 6B.

### Examples

### Stability

As mentioned above, in an Al core TiO₂ shell nanostructure, it may be desirable for the shell to be mechanically robust and fully closed. In view of the above examples, it is believed that the current TiO₂ shells do at least partially enclose the internal cores such that they at least partially protect the Al core from external material. To verify this behavior, XRD characterization of Al core and TiO₂ shell powders was done after exposure to ambient air for 24 hr and grinding in air for 20 min followed by exposure to air for another 24 hr. As illustrated in FIG. 9, no alumina peaks were detected in either case indicating negligible oxidation of the aluminum cores within the protective outer shells during the handling and processing of the materials. Therefore, it is reasonable to conclude that Al core and TiO₂ shell nanoparticles are air stable for at least 24 hr and the TiO₂ shell is mechanically robust enough to survive the mixing and handling processes expected during electrode preparation.

### Examples

### Hollow Shells

Hollow TiO₂ shells (without Al) were obtained using the above noted processes and an etching time of 24 hr. The presence of hollow shells was confirmed by the obvious contrast between the edge and the center of the nanoparticles shown in FIG. 10. The battery performance of the hollow TiO₂ shells was characterized, as shown in FIGS. 11A and 11B. The reversible capacity was 112 mAh/g for the first cycle and stabilized at 111 mAh/g for later cycles at a rate of 1 C. The average Coulombic Efficiency was about 99.83% throughout the 500 cycles. The high reversibility also indicates the pseudocapacitive nature of the hollow TiO₂ shells.

### Examples

### ATO Low C Rate Cycling Performance

The cycle performance at a slow rate of 0.1 C was also used to characterized ATO performance over 100 cycles to evaluate if there was a time dependent component associated with SEI formation and/or observed capacity fade, see FIGS. 12A and 12B. As shown in the figures, the reversible capacity is 1638 mAh/g for the first cycle and stabilizes at 1599 mAh/g for later cycles at a charge discharge rate of 0.1 C. The average Coulombic Efficiency is about 99.41% in the first 100 cycles. In view of the above, the observed capacity fade does not appear to be significantly impacted by time.

### Examples

### Crystal Structure Evolution

FIG. 13 shows the XRD pattern of an Al core and TiO2 shell nanoparticle anode before and after various numbers of cycles up to 511 cycles. As shown in the figure, with increasing cycles, the Al FCC diffraction peaks at 38°, 44°, 65° and 78° decreases, which indicate the aluminum inside likely has turned amorphous.

### Examples

### Capacity Fade for Different Charge Discharge Rates

FIGS. 14A and 14B present the capacities for ATO when subjected to different C rates varying from a 1.0 C rate to a 10.0 C rate. When referenced to aluminum as the active material, for a comparison, the specific capacity of an Al core and TiO₂ shell nanoparticle based electroactive material was calculated for different cycles and rates. As shown in FIG. 14B, specific capacities of 1205 mAh/g (1 C), 1028 mAh/g (2 C), 795 mAh/g (5 C), and 647 mAh/g (10 C) after 500 cycles were measured for ATO, which further indicates the outstanding battery performance of an ATO electrode.

### Examples

### Reversible Redox Shuttle

In the half-cell experiments, the average Coulombic Efficiency from the 1^{st} to 500^{th} cycle was calculated to be 99.2%. However the 0.8% AWOL electrons are not all generating irreversible SEI as noted above. Without wishing to be bound by theory, it is believed the AWOL electrons are forming a reversible redox shuttle inside the electrolyte, as illustrated in FIG. 18, and is believed to be water related. Specifically, when there is a little bit of residual water in the electrode, which is reasonable in the current materials considering the electrodes were prepared in a moisture-containing environment, the redox shuttle mechanism may be activated between the Al core and TiO₂ shell (ATO) cathode and lithium anode. During discharging, the absorbed water would first receive electrons (H₂O+e⁻→H.+OH⁻), producing hydrogen radicals (H.). Then the active hydrogen would preferably attach to the organic electrolyte, ethylene carbonate ((CH₂O)₂C), for example, with the lone pair of the oxygen atom of carbonyl group in the EC interacting with the unsaturated hydrogen radical.

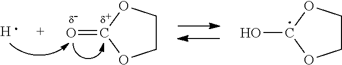

In this form, the hydrogen radical is protected from intermolecular annihilation and thus stabilized to survive the diffusion circle. Once the W is translated to the lithium metal, it would release the electron to form H⁺ again (H.→H⁺+e⁻), which would diffuse back to the Al core and TiO₂ shell electrode. The “oxidation-diffusion-reduction-diffusion” cycle can be repeated continuously due to the reversible nature of the redox shuttle. An estimation based on Faraday's law predicts that when the water fraction reaches 0.2% of the active materials, the Coulombic Efficiency loss that comes from the residual water approaches 0.5%.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

What is claimed is:

1. An electroactive material comprising:
an aluminum nanoparticle core;
a nanoshell surrounding the aluminum nanoparticle core.

2. The electroactive material of claim 1, wherein the nanoshell fully encloses the aluminum nanoparticle core.

3. The electroactive material of claim 1, further comprising a plurality of aluminum nanoparticle cores, and wherein the nanoshell surrounds the plurality of aluminum nanoparticle cores.

4. The electroactive material of claim 1, wherein a volume enclosed by the nanoshell is greater than or equal to twice a volume of the aluminum nanoparticle core.

5. The electroactive material of claim 4, wherein a volume enclosed by the nanoshell is less than or equal to four times a volume of the aluminum nanoparticle core.

6. The electroactive material of claim 1, wherein the nanoshell is permeable to ionic lithium.

7. The electroactive material of claim 6, wherein the nanoshell is impermeable to organic electrolytes.

8. Electroactive material of claim 1, wherein a size of defects in the nanoshell is less than or equal to about 700 picometers.

9. The electroactive material of claim 1, wherein the nanoshell comprises TiO₂.

10. The electroactive material of claim 8, wherein the TiO₂ has an anatase crystal structure.

11. The electroactive material of claim 1, wherein the aluminum nanoparticle core has a maximum diameter that is greater than 0 nm and is less than or equal to 100 nm.

12. The electroactive material of claim 11, wherein the nanoshell has a maximum thickness between or equal to 1 nm and 10 nm.

13. The electroactive material of claim 12, wherein the nanoshell has a maximum thickness between or equal to 1 nm and 5 nm.

14. A material comprising:
a nanoshell of TiO₂, wherein a maximum diameter of the nanoshell is between about 10 nm and 100 nm, and wherein a maximum thickness of the nanoshell is between about 1 nm and 10 nm.

15. The material of claim 14, wherein the TiO₂ has an anatase crystal structure.

16. The material of claim 14, further comprising an aluminum nanoparticle core disposed in the nanoshell, wherein the aluminum nanoparticle has a diameter that is greater than 0 nm and is less than or equal to 100 nm.

17. The material of claim 14, wherein the nanoshell has a thickness between or equal to 1 nm and 5 nm.

18. A method comprising:
placing an aluminum nanoparticle having an outer layer of alumina on its exterior surface in an acid bath saturated with TiO(OH)₂;
reacting the alumina present on the aluminum nanoparticle with the acid bath to produce water as a product;
reacting the water with a titanium containing compound in the acid bath to precipitate TiO(OH)₂ onto the exterior surfaces of the aluminum nanoparticle to form a nanoshell on the aluminum nanoparticle.

19. The method of claim 18, further comprising etching the aluminum nanoparticle through the nano shell.

20. The method of claim 18, further comprising calcining the nanoshell to form TiO₂.

21. The method of claim 20, wherein calcining the nanoshell further comprises annealing the aluminum nanoparticle and nanoshell at a temperature between 100° C. and 480° C.

22. An electrochemical device comprising:
a current collector; and
an electroactive material electrochemically coupled to the current collector, wherein the electroactive material includes an aluminum nanoparticle core surrounded by a nano shell.
